(19) United States
(12) Patent Application Publication
(10) Pub. No.: US 2026/0088212 A1
(43) Pub. Date: Mar. 26, 2026

(54) COIL COMPONENT AND ELECTRONIC/ELECTRIC DEVICE

(71) Applicant: DELTA ELECTRONICS (JAPAN), INC., Tokyo (JP)

(72) Inventors: Kenichi IKEDA, Tokyo (JP); Yohei NOMURA, Tokyo (JP); Keiichi ARAKI, Tokyo (JP); Naoki SAKAZUME, Tokyo (JP); Kenji HASHIZAKI, Tokyo (JP)

(73) Assignee: DELTA ELECTRONICS (JAPAN), INC., Tokyo (JP)

(21) Appl. No.: 19/403,271

(22) Filed: Nov. 28, 2025

Related U.S. Application Data
(63) Continuation of application No. PCT/JP2023/020045, filed on May 30, 2023.

(51) Int. Cl. H01F 27/29; H01F 27/02; H01F 27/255

(52) U.S. Cl. CPC H01F 27/292; H01F 27/02; H01F 27/255

(57) ABSTRACT

A coil component having a coil structure excellent in inductance characteristics includes a coil member and a main body. The coil member includes an annular conductor including a pair of bottom surfaces in a first direction and revolving around a central axis. The main body covers the bottom surfaces of the annular conductor with intersecting surfaces arranged in the first direction and contains magnetic powder. The annular conductor includes a first bottom surface facing one of the intersecting surfaces, and a second bottom surface facing the other of the intersecting surfaces, and further includes an inner surface and an outer surface between the first and second bottom surfaces. The first bottom surface has an inner tapered part farther from the first main body surface toward the inner surface. An inclination angle of the inner tapered part with respect to a plane orthogonal to the first direction is 50° or less.

### CROSS REFERENCE TO RELATED APPLICATIONS

This application is a continuation application of PCT Application No. PCT/JP2023/020045, filed on May 30, 2023. The content of the application is incorporated herein by reference.

### BACKGROUND OF THE INVENTION

### 1. Field of the Invention

The present invention relates to a coil component and an electronic/electric device, in which the coil component is installed.

### 2. Description of the Related Art

Patent document 1 discloses a chip electronic component that includes an insulating substrate, a magnetic body including a coil conductor pattern formed on at least one surface of the insulating substrate, and external electrodes formed on both ends of the magnetic body so as to be connected to the ends of the coil conductor pattern, and in a longitudinal cross section of the magnetic body, the thickness of the innermost coil conductor pattern among the coil conductor patterns is thinner than the thickness of the other coil conductor patterns.

### PRIOR ART DOCUMENT

### [Patent Document]

[Patent Document 1] Japanese Patent Publication No. 2015-220452

### SUMMARY OF THE INVENTION

### Problems to be Solved by the Invention

Patent Document 1 describes that “the coil conductor pattern constituting the inductor is arranged in order from the outermost coil conductor pattern to the innermost coil conductor pattern, that is, the coil width becomes narrower from the outside toward the inside, which can be the optimal coil structure for improving inductor characteristics”. The above-described invention is a method for realizing such a coil structure.

The present invention is to provide a coil component having a coil structure with excellent inductor characteristics from a perspective different from the invention described in Patent Document 1. The present invention also aims to provide an electronic/electric device, in which the coil component is installed.

### Means to Solve the Problems

The present invention, in one aspect, provides a coil component comprising: a coil conductor portion including an annular conductor portion, which has a pair of bottom surfaces arranged in a first direction and revolves around a first central axis along the first direction; and a main body portion, which covers the pair of bottom surfaces of the annular conductor portion with a pair of intersecting surfaces arranged in the first direction and contains a magnetic powder. The annular conductor portion includes a first bottom surface facing a first main body surface, which is one of the pair of intersecting surfaces; a second bottom surface facing a second main body surface, which is the other of the pair of intersecting surfaces; and a first inner surface and a first outer surface located between the first bottom surface and the second bottom surface. The first bottom surface includes a first inner tapered part configured so that the first bottom surface is farther from the first main body surface toward the first inner surface. A first inner inclination angle θ1 of the first inner tapered part with respect to a plane orthogonal to the first direction may be 50° or less. Since the coil component includes the first inner tapered part with the appropriate first inner inclination angle θ1, a local increase in a magnetic resistance is less likely to occur in the magnetic path, which is generated in the main body portion to circulate around the annular conductor portion when current flows through the coil component.

In the coil component described above, the second bottom surface may have a second inner tapered part configured so that the second bottom surface is farther from the second main body surface toward the first inner surface. A second inner inclination angle θ2 of the second inner tapered part with respect to a plane orthogonal to the first direction may be 50° or less.

The coil component described above includes an annular conductor portion having a first annular conductor portion and a second annular conductor portion, which are symmetrical with respect to a plane orthogonal to a first direction. A first inner tapered part is provided in the first annular conductor portion, and a second inner tapered part is provided in the second annular conductor portion. In a case where an average length of the first annular conductor portion in the first direction is defined as t (unit: μm), an average gap distance in the first direction between an end part of the first bottom surface of the first annular conductor portion and the first main body surface is defined as h (unit: μm), and an average gap distance in the first direction between an outer peripheral edge and an inner peripheral edge of the first inner tapered part is defined as p0 (unit: μm), the following expression (1) may be satisfied:

$$t / h \times 25 μ m - 4.85 μ m \leq p 0 \leq t / h \times 25 μ m + 5.15 μ m . \qquad ( 1 )$$

In the coil component satisfying the above expression (1) described above, when t/h is defined as a first ratio, it may be preferable that p0 is 10 μm or more and 20 μm or less when the first ratio is less than 1.0, p0 is 25 μm or more and 35 μm or less when the first ratio is 1.0 or more and less than 1.5, and p0 is 45 μm or more and 55 μm or less when the first ratio is 1.5 or more.

In the coil component described above, the annular conductor portion may have a first inner corner part that connects the first inner surface and the first inner tapered part with a continuous surface.

In the above-described coil component, when the coil component is cut along the first direction through the first inner surface to obtain a first cross section, which has a minimal cross-sectional area of the first annular conductor portion, the cross-sectional line, by which a first inner corner part is drawn on the first cross section, has a shape approximated by an arc of a circle having a radius s0 (unit: μm).

In the coil component described above, the second bottom surface may have a second inner tapered part configured so that the second bottom surface is farther from the second main body surface toward the first inner surface. A second inner inclination angle θ2 of the second inner tapered part with respect to a plane orthogonal to the first direction may be 50° or less.

In the coil component having the second inner tapered part described above, the annular conductor portion includes: a first spiral conductor portion having a pair of bottom surfaces arranged in the first direction and having a plurality of turns that go around the first central axis; a second spiral conductor portion having a pair of bottom surfaces arranged in the first direction, having a plurality of turns that go around the first central axis from an inner side to an outer side, and aligned with the first spiral conductor portion in the first direction; a via member in contact with one end of the inner side of the first spiral conductor portion and one end of the inner side of the second spiral conductor portion to electrically connect the first spiral conductor portion and the second spiral conductor portion. The first inner tapered part is provided on the side where the first spiral conductor portion is located in the first direction, and the second inner tapered portion is provided on the side where the second spiral conductor portion is located in the first direction.

In the coil component described above, the first bottom surface comprises a first outer tapered part configured so that the first bottom surface is farther from the first main body surface toward the first outer surface; and a first outer inclination angle @1 of the first outer tapered part with respect to a plane orthogonal to the first direction is 50° or less.

In the coil component described above, the second bottom surface comprises a second outer tapered part configured so that the second bottom surface is farther from the second main body surface toward the first outer surface. A second outer inclination angle φ2 of the second outer tapered part with respect to a plane orthogonal to the first direction may be 50° or less.

In the coil component having the first outer tapered part described above, the annular conductor portion may comprise a first inner corner part connecting the first inner surface and the first inner tapered part with a continuous surface, and a first outer corner part connecting the first outer surface and the first outer tapered part with a continuous surface.

In the coil component having the first inner corner part and the first outer corner part described above, when the annular conductor portion is cut at a first cross section orthogonal to a current path of the annular conductor portion and along the first direction, a cross-sectional line, by which the first inner corner part is drawn on the first cross section, has a shape approximated by an arc of a circle having a radius s0 (unit: μm), and a cross-sectional line, by which the first outer corner part is drawn on the first cross section, has a shape approximated by an arc of a circle having a radius sn (unit: μm), wherein sn/s0 may be 0.8 or more and 1.2 or less.

In the coil component having the first outer tapered part described above, when the annular conductor portion is cut at a first cross section orthogonal to a current path of the annular conductor portion and along the first direction, in at least a part of a cross-sectional line, by which a portion of the first bottom surface other than the first inner tapered part and other than the first outer tapered part is drawn on the first cross section, an inclination angle with respect to the first direction may be other than 90°.

In the coil component described above, in a case where an average length of the first annular conductor portion in the first direction is set to be a turn width t (unit: μm), an average gap distance in the first direction between a portion of the first bottom surface, where the first inner tapered part is not provided, and the first main body surface is set to be a top-bottom thickness h (unit: μm), and an average gap distance viewed in the first direction between an outer peripheral edge and an inner peripheral edge of the first inner tapered part is set to be an inner chamfer width p0 (unit: μm), a first parameter defined as p0×h/t may be 5.0 μm⁻¹ or more and 35 μm⁻¹ or less.

In the coil component described above, an inner peripheral edge of the annular conductor portion, when viewed in the first direction, has a shape approximated by an inner elongated circle, which is an elongated circle including two semicircle portions, each having a radius r0 (unit: μm), and a linear portion extending in a second direction orthogonal to the first direction between the two semicircle portions and having a length a0 (unit: μm). An outer peripheral edge of the annular conductor portion, when viewed in the first direction, has a shape approximated by an outer elongated circle, which is an elongated circle including two semicircle portions, having same centers as those of the two semicircle portions of the inner elongated circle and each having a radius rn (unit: μm), and a linear portion extending in the second direction between the two semicircle portions and having a length an (unit: μm). An intermediate elongated circle is defined as an elongated circle between the inner elongated circle and the outer elongated circle, including two semicircle portions having same centers as those of the two semicircle portions of the inner elongated circle. The intermediate elongated circle includes the two semicircle portions having a radius ri (unit: μm), respectively, and a linear portion having a length ai (unit: μm). When an average gap distance between the annular conductor portion at a position of the intermediate elongated circle and the first main body surface is defined as hi (unit: μm), a second parameter defined by 2×(π×ri+ai)×hi/r0/(π×r0+2×a0) may be 0.8 or more and 1.2 or less.

In the coil component described above, an inner peripheral edge of the annular conductor portion, when viewed in the first direction, has a shape approximated by an inner elongated circle, which is an elongated circle including two semicircle portions, each having a radius r0 (μm), and a linear portion extending in a second direction orthogonal to the first direction between the two semicircle portions and having a length a0 (μm). An outer peripheral edge of the annular conductor portion, when viewed in the first direction, has a shape approximated by an outer elongated circle, which is an elongated circle including two semicircle portions, having same centers as those of the two semicircle portions of the inner elongated circle and each having a radius rn (μm), and a linear portion extending in the second direction between the two semicircle portions and having a length an (μm). In a case where a taper-end elongated circle is defined as an elongated circle between the inner elongated circle and the outer elongated circle, which includes two semicircle portions having same centers as those of the two semicircle portions of the inner elongated circle, and is an elongated circle closest to an outer peripheral edge of the first inner tapered part, a third parameter represented by XY² may be 0.0020 or more and 0.20 or less, wherein X is represented by an expression (2) and Y is represented by an expression (3):

$$X = 1 - p {0}^{2} / ( 2 \times t \times W ) \times tan θ 1 \qquad ( 2 )$$

$$Y = min [ min ( A 0 , A 1 ) - A 0 ini ) / ( Ain - A 0 ini ) , 1 ] . \qquad ( 3 )$$

Herein, p₀ (unit: μm) is an average gap distance in the first direction between an outer peripheral edge and an inner peripheral edge of the first inner tapered part. W (unit: μm) is a width of a turn forming the annular conductor portion in a direction orthogonal to the first direction. min (α, β) is a function to return the smaller of α and β. A0 (unit: μm²) is an area of a first inner cross section obtained by cutting a first portion, which is located between the first main body surface and the annular conductor portion in the main body portion, along a cutting plane passing through the inner elongated circle and extending in the first direction. A1 (unit: μm²) is an area of a first taper-end cross section obtained by cutting the first portion along a cutting plane passing through the taper-end elongated circle and extending in the first direction. Ain (unit: μm²) is an area of the inner elongated circle as viewed in the first direction. A0ini (unit: μm²) is an area of a virtual inner cross section obtained by cutting a virtual member, in which the annular conductor portion 203 does not include the first inner tapered part 11T, along a cutting plane passing through the inner elongated circle Ovo and extending in the first direction.

In the coil component described above, an inner peripheral edge of the annular conductor portion, when viewed in the first direction, has a shape approximated by an inner elongated circle, which is an elongated circle including two semicircle portions, each having a radius r0 (μm), and a linear portion extending in a second direction orthogonal to the first direction between the two semicircle portions and having a length a0 (μm). An outer peripheral edge of the annular conductor portion, when viewed in the first direction, has a shape approximated by an outer elongated circle, which is an elongated circle including two semicircle portions, having same centers as those of the two semicircle portions of the inner elongated circle and each having a radius rn (μm), and a linear portion extending in the second direction between the two semicircle portions and having a length an (μm). In a case where a taper-end elongated circle is defined as an elongated circle between the inner elongated circle and the outer elongated circle, which includes two semicircle portions having same centers as those of the two semicircle portions of the inner elongated circle, and is an elongated circle closest to an outer peripheral edge of the first inner tapered part, a fourth parameter represented by Z with an expression (4) may be 0.80 or less:

$$Z = p 0 / [ \{ r 0 \times ( π r 0 + 2 \times a 0 ) / ( 2 \times π \times h 1 ) \} - ( a 1 / π ) - r 0 ] \times [ tan θ 1 - π \times h 0 / \{ π \times ( r 0 + p 0 ) + a 0 \} ] . \qquad ( 4 )$$

Herein, p0 (unit: μm) is an average gap distance in the first direction between an outer peripheral edge and an inner peripheral edge of the first inner tapered part. r1 (unit: μm) is a radius of each of two semicircle portions of the taper-end elongated circle. a1 (unit: μm) is a length of a linear portion of the taper-end elongated circle. h1 (unit: μm) is an average gap distance between the annular conductor portion at a position of the taper-end elongated circle and the first main body surface. In this case, the inner peripheral edge of the annular conductor portion may have a substantially circular shape.

The present invention, in another aspect, provides an electronic/electric device, installed therein the coil component described above. The coil component includes a pair of external electrodes connected to a pair of end parts of the coil member, and is connected to a substrate via the pair of external electrodes. As examples of the electronic/electric devices, a power supply device including a power switching circuit, a voltage step-up/step-down circuit, and a smoothing circuit, as well as a compact portable communication device, can be given. Since the electronic/electric device according to the present invention includes the above-described coil component, it exhibits excellent comprehensive characteristics as an inductance element.

### Effect of the Invention

The annular conductor portion provided in the coil component according to the present invention has a tapered portion inclined at an appropriate angle with respect to the main body surface. Therefore, in the magnetic path generated in the main body portion so as to circulate around the annular conductor portion when current flows through the coil component, a local increase in magnetic resistance is less likely to occur. Therefore, the coil component according to the present invention has excellent comprehensive characteristics L×Isat/DCR. When the coil component is mounted in electronic/electric device, the performance of the electronic/electric device can be improved, and the dimensions of the electronic/electric device can be reduced. Furthermore, according to the present invention, an electronic/electric device, in which an excellent coil component is installed, is provided.

### BRIEF DESCRIPTION OF THE DRAWINGS

FIG. 1 is a perspective view conceptually illustrating the shape of a coil component according to a first embodiment of the present invention.

FIG. 2 is a diagram illustrating the structure of a coil conductor portion provided in the coil component according to the first embodiment of the present invention.

FIG. 3 is an XY plan view illustrating the structure of a first spiral conductor portion provided in the coil component according to the first embodiment of the present invention.

FIG. 4 is an XY plan view illustrating the structure of a second spiral conductor portion provided in the coil component according to the first embodiment of the present invention.

FIG. 5A is a YZ cross-sectional view taken along line A-A′ in FIG. 3.

FIG. 5B is an enlarged view of the region enclosed by the bold broken line in FIG. 5A.

FIG. 6 is a plan view and a YZ cross-sectional view taken along line B-B′ of the plan view, illustrating the configuration of a coil component according to a second embodiment of the present invention.

FIG. 7 is an enlarged view of the region enclosed by the thick dotted line in the YZ cross-sectional view of FIG. 6.

FIG. 8A is a diagram illustrating an outline of the shape of a coil component belonging to Series A.

FIG. 8B is a diagram illustrating an outline of the shape of a coil component belonging to Series B.

FIG. 8C is a diagram illustrating an outline of the shape of a coil component belonging to Series C.

FIG. 8D is a diagram illustrating an outline of the shape of a coil component belonging to Series D.

FIG. 8E is a diagram illustrating an outline of the shape of a coil component belonging to Series D.

FIG. 8F is a diagram illustrating an outline of the shape of a coil component belonging to Series E.

FIG. 8G is a diagram illustrating an outline of the shape of a coil component belonging to Series F.

FIG. 8H is a diagram illustrating an outline of the shape of a coil component belonging to Series G.

FIG. 9 is a graph showing the comprehensive characteristic L×Isat/DCR for the coil components 100 of Series A to Series C.

FIG. 10 is a graph showing the comprehensive characteristic L×Isat/DCR for the coil components 100 of Series D.

FIG. 11 is a graph showing the comprehensive characteristic Lx Isat/DCR for the coil components 100 of Series E to Series G.

FIG. 12 is a graph showing the dependence of a first ratio (t/h) on an inner chamfer width p0.

FIG. 13A is a plan view and a YZ cross-sectional view taken along line C-C′ of the plan view, illustrating the configuration of a coil component according to a third embodiment of the present invention.

FIG. 13B is a plan view and a YZ cross-sectional view taken along line D-D′ of the plan view, illustrating the configuration of a coil component according to a fourth embodiment of the present invention.

FIG. 13C is a plan view and a YZ cross-sectional view taken along line E-E′ of the plan view, illustrating the configuration of a coil component according to a fifth embodiment of the present invention.

FIG. 14 is a plan view and a YZ cross-sectional view taken along line F-F′ of the plan view, illustrating the structure of a coil component according to a sixth embodiment of the present invention.

FIG. 15A is a YZ cross-sectional view illustrating the structure of a coil component according to a seventh embodiment of the present invention.

FIG. 15B is an enlarged view of the region enclosed by the bold broken line in FIG. 15A.

FIG. 15C is a diagram illustrating the structure of a coil component according to a modified example of the seventh embodiment, showing the same range as FIG. 15B.

FIG. 16 is a YZ cross-sectional view illustrating the structure of a coil component according to an eighth embodiment of the present invention.

FIG. 17 is a YZ cross-sectional view illustrating the structure of a coil component according to a ninth embodiment of the present invention.

FIG. 18 is a YZ cross-sectional view illustrating the structure of a coil component according to a tenth embodiment of the present invention.

FIG. 19 is a graph illustrating the shape-related characteristics of a coil component according to an embodiment of the present invention, showing the relationship between comprehensive characteristic L×Isat/DCR and p0×h/t.

FIG. 20A is a graph illustrating the shape-related characteristics of a coil component according to an embodiment of the present invention, showing the relationship between the change rate Δ of comprehensive characteristic L×Isat/DCR and a third parameter (XY²).

FIG. 20B is a graph in which the range of the horizontal axis in the graph shown in FIG. 20A is set to 0.00 to 0.30.

FIG. 21 is a graph illustrating the shape-related characteristics of a coil component according to an embodiment of the present invention, showing the relationship between the change rate Δ of comprehensive characteristic L×Isat/DCR and a fourth parameter (Z).

### DETAILED DESCRIPTION

Below, embodiments according to the present invention will be described in detail with reference to the drawings.

### First Embodiment

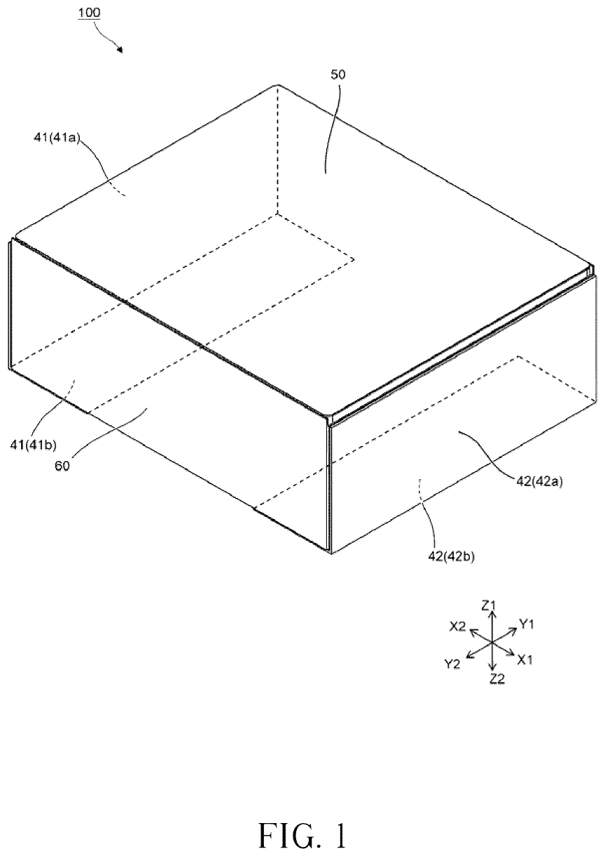

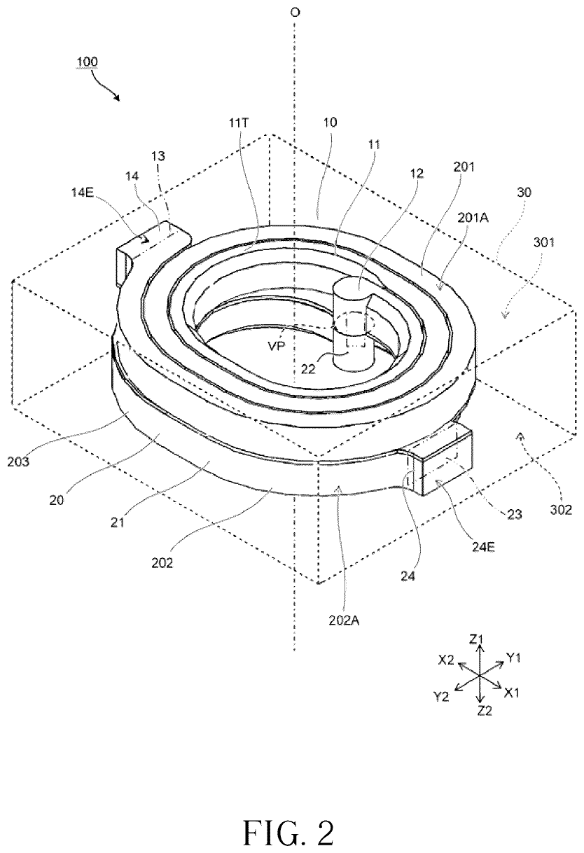

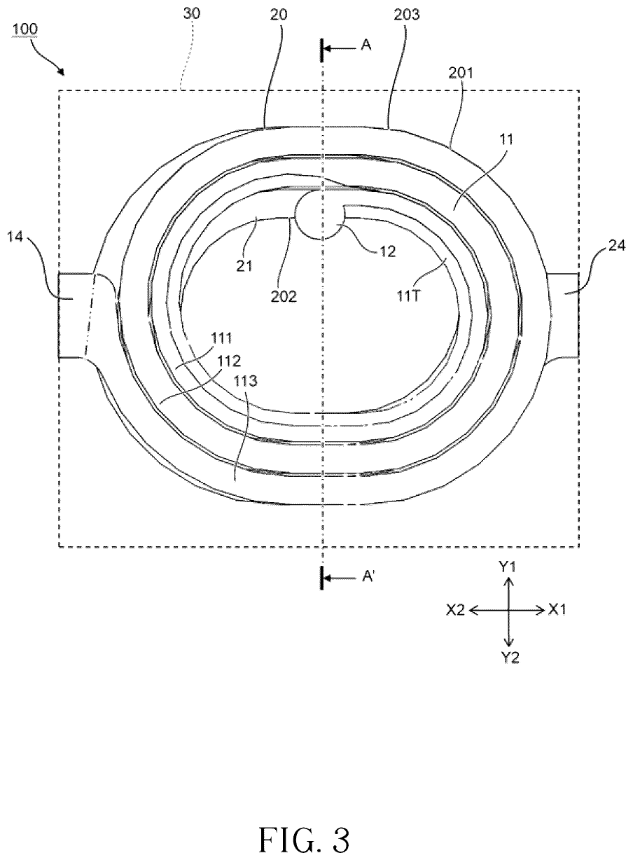

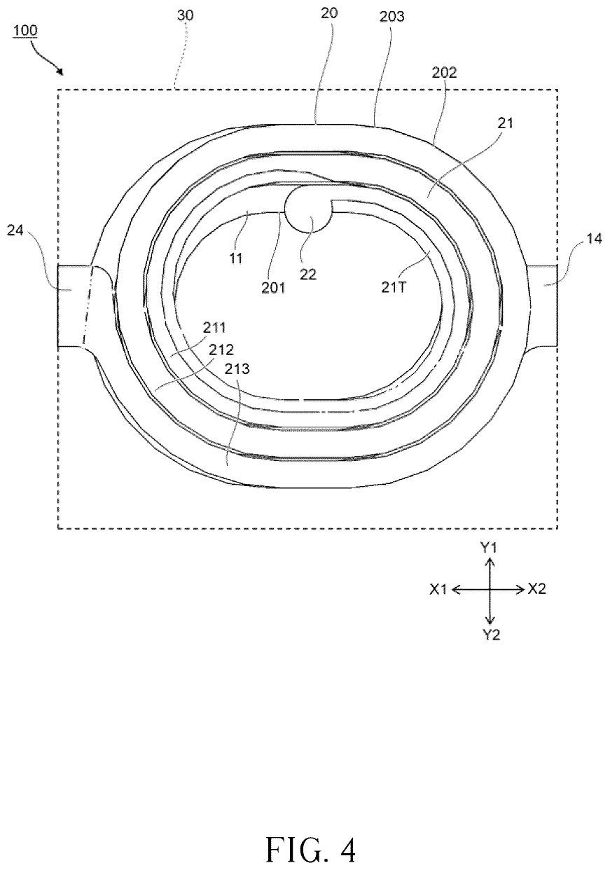

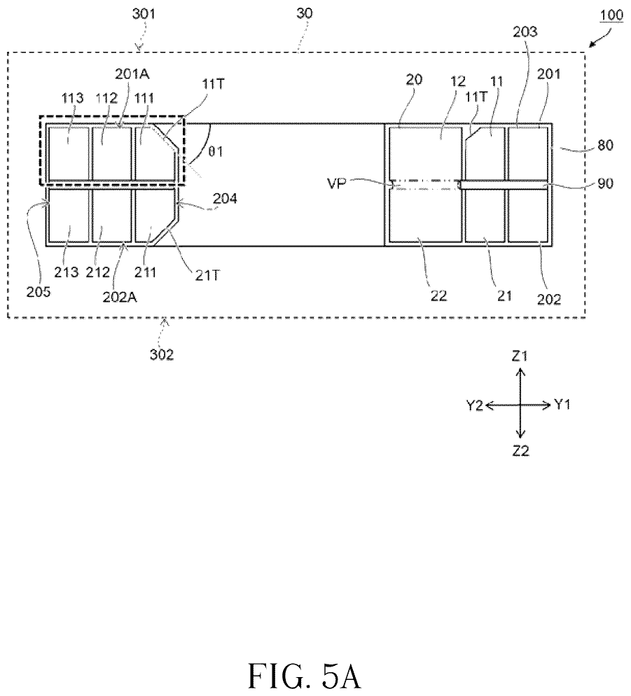

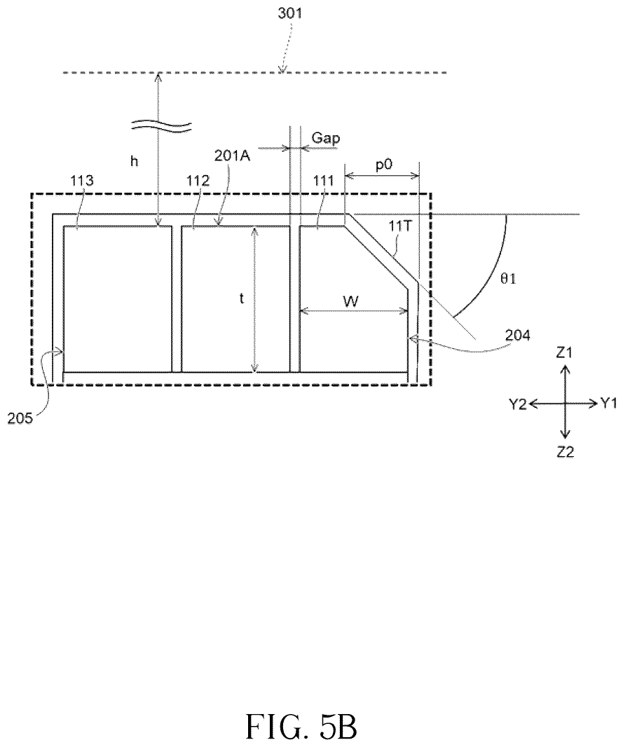

FIG. 1 is a perspective view conceptually illustrating the shape of a coil component according to a first embodiment of the present invention. FIG. 2 is a diagram illustrating the structure of a coil conductor portion provided in the coil component according to the first embodiment of the present invention. FIG. 3 is an XY plan view (from Z1 side in Z1-Z2 direction) illustrating the structure of a first spiral conductor portion provided in the coil component according to the first embodiment of the present invention. FIG. 4 is an XY plan view (from Z1 side in Z1-Z2 direction) illustrating the structure of a second spiral conductor portion provided in the coil component according to the first embodiment of the present invention. FIG. 5A is a YZ cross-sectional view taken along line A-A′ in FIG. 3. FIG. 5B is an enlarged view of the region enclosed by the bold broken line in FIG. 5A. In FIG. 2 through FIG. 4, for illustration purposes, the coil conductor portion is drawn with solid lines, the main body portion is drawn with dashed lines, and other components are omitted. Similarly, in FIG. 5A and FIG. 5B, for illustration purposes, the coil member is drawn with solid lines, the main body portion is drawn with dashed lines, and other components are omitted.

The coil component 100 according to the first embodiment of the present invention comprises a coil member 10 having a coil conductor portion 20, a main body portion 30, a first external electrode 41, a second external electrode 42, and outer covers 50, 60.

As shown in FIG. 2 and FIG. 3, the coil member 10 revolves around a first central axis (axis O), which extends along a first direction (Z1-Z2 direction), from one end part 12, which is an inner side end part in the first spiral conductor portion 11, toward the other end part 13, which is an outer side end part in the first spiral conductor portion 11, in a spiral shape that moves away from axis O. The first spiral conductor portion 11 is a specific example of a first annular conductor portion, which is part of the coil conductor portion 20 and includes an annular conductor portion 203 having a pair of bottom surfaces (first bottom surface 201A, second bottom surface 202A) aligned in a first direction (Z1-Z2 direction). In FIG. 2, viewed from the Z1 side in the Z1-Z2 direction, the conductors of the first spiral conductor portion 11 are arranged in a spiral pattern moving clockwise away from the axis O from the end part 12 toward the end part 13. In this specification, the “spiral direction” of the coil member means the direction from the inner side end toward the outer side end. A first lead conductor part 14 is connected to the end part 13 of the first coil conductor portion 11 as a part of the first coil conductor portion 201.

As shown in FIG. 2 and FIG. 4, the coil conductor portion 20 includes a second coil conductor portion 202 having a second spiral conductor portion 21 arranged alongside the first spiral conductor portion 11 in the first direction. In this embodiment, the second spiral conductor portion 21 is a specific example of a second annular conductor portion including an annular conductor portion 203. The annular conductor portion 203 is formed with the first spiral conductor portion 11 and the second spiral conductor portion 21. The first spiral conductor portion 11 and the second spiral conductor portion 21 are symmetrical (planar symmetrical) with respect to a plane (XY plane) perpendicular to the first direction (Z1-Z2 direction). Specifically, the second spiral conductor portion 21 has a spiral shape that extends away from the axis O around the axis O along the first direction (Z1-Z2 direction), from one end part 22, which is the inner side end part in the second spiral conductor portion 21, toward the other end part 23, which is the outer side end part in the second spiral conductor portion 21. In the second spiral conductor portion 21, viewed from the Z1 side in the Z1-Z2 direction, the conductor is arranged in a spiral pattern moving away from the axis O in the opposite direction (counterclockwise in FIG. 2) to the first spiral conductor portion 11. A second lead conductor part 24 is connected to the end part 23 of the second spiral conductor portion 21 as a part of the second coil conductor portion 202.

The conductor (conductive material) constituting the coil conductor portion 20 is not limited as long as it possesses appropriate conductivity. Metals such as copper, copper alloys, aluminum, and aluminum alloys are specific examples of conductors constituting the coil conductor portion 20, and the coil conductor portion 20 can be manufactured using film formation techniques such as plating.

The coil member 10 has an insulating coil insulator portion (not shown in FIG. 1 to FIG. 4) on the surface of the coil conductor portion 20. This coil insulation portion ensures insulation between adjacent conductors (between the surfaces of the conductors facing each other) in the coil conductor portion 20. The coil insulation portion is composed of, for example, a resin material. The coil insulator portion is not provided at the ends (first lead conductor end face 14E and second lead conductor end face 24E) of the two end parts (first lead conductor part 14 and the second lead conductor part 24) of the coil conductor portion 20. The coil member 10 can be electrically connected to other components at these ends.

As shown in FIG. 2 to FIG. 4, each turn of the first spiral conductor portion 11 and each turn of the second spiral conductor portion 21 are positioned to align in the first direction (Z1-Z2 direction). As shown in FIG. 3, the first spiral conductor portion 11 includes a first inner-side turn 111 located at the innermost periphery, a first outer-side turn 113 located at the outermost periphery, and a first central turn 112 located between the inner-side turn and the outer-side turn. As shown in FIG. 4, the second spiral conductor portion 21 includes a second inner-side turn 211 located at the innermost periphery, a second outer-side turn 213 located at the outermost periphery, and a second central turn 212 located between the inner turn and the outer-side turn.

The second inner-side turn 211 is positioned on the Z2 side of the first inner-side turn 111 in the Z1-Z2 direction. The second outer-side turn 213 is positioned on the Z2 side of the first outer-side turn 113 in the Z1-Z2 direction.

The average value of a gap distance in the first direction (Z1-Z2 direction) between the first spiral conductor portion 11 and the second spiral conductor portion 21 is not particularly limited. A smaller gap distance facilitates reducing the height (Z1-Z2 dimension) of the coil component 100; however, an excessively small distance may impair the insulation between the first spiral conductor portion 11 and the second spiral conductor portion 21. From the perspective of achieving both a low profile (low height) as the coil component 100 and high insulation between the first coil conductor portion 11 and the second coil conductor portion 21, it may be preferable for the gap distance to be 0.4 μm or more and 20 μm or less. The gap distance is preferably 1.0 μm or greater, and more preferably 5.0 μm or greater, in order to reduce variation in the gap distance during the manufacturing process and to more reliably support the coil in the same plane.

The main body portion 30 contains magnetic powder and covers the pair of bottom surfaces of the first spiral conductor portion 11 with a pair of intersecting surfaces (first main body surface 301, second main body surface 302) aligned in the first direction (Z1-Z2 direction), thereby enclosing a portion of the coil member 10. In this embodiment, the main body portion 30 has a substantially rectangular parallelepiped shape and contains portions except for the outermost end face (X2 side in X1-X2 direction) of the first lead conductor part 14 and the outermost end face (X1 side in X1-X2 direction) of the second lead conductor part 24, which are disposed at ends of the coil member 10. The dimensions of the main body portion 30 are not limited. For example, the maximum dimension of the main body portion 30 may be 3.2 mm or less. Details of the magnetic powder constituting the main body portion 30 will be described later.

In this embodiment, as shown in FIG. 5A and FIG. 5B, the annular conductor portion 203 has a first bottom surface 201A facing the first main body surface 301, which is one of the pair of intersecting surfaces; a second bottom surface 202A facing the second main body surface 302, which is the other of the pair of intersecting surfaces; and a first inner surface 204 and a first outer surface 205 positioned between the first bottom surface 201A and the second bottom surface 202A.

The first bottom surface 201A of the annular conductor portion 203 has a first inner tapered part 11T that becomes more distant from the first body surface 301 as it approaches the first inner surface 204. A first inner inclination angle θ1 of the first inner tapered part 11T with respect to a plane (XY plane) orthogonal to the first direction (Z1-Z2 direction) is 50° or less. Accordingly, when the coil component 100 is energized during use, in a magnetic path formed inside the main body portion 30 so as to circulate around the annular conductor portion 203, e.g., a circuit that proceeds along the first inner surface 204 in the first direction, proceeds along the first bottom surface 201A in a direction orthogonal to the first direction, proceeds along the first outer surface 205 in the first direction, proceeds along the second bottom surface 202A in a direction orthogonal to the first direction, and returns to the first inner surface 204, or a circuit circulating in the opposite direction, magnetic resistance increasing locally at a specified portion is less likely to occur. Therefore, the coil component 100, as an inductance element, can exhibit enhanced properties in, for example, comprehensive characteristic L×Isat/DCR (unit: mH·AΩ⁻¹) expressed by self-inductance L, DC superimposition rated current Isat, and DC resistance DCR. In this specification, the DC superimposition rated current Isat means a current value at which the self-inductance L decreases by 30% when DC is superimposed. From the viewpoint of more stably improving the characteristics of the coil component 100, the first inner inclination angle θ1 may preferably be 40° or more and 45° or less.

The second bottom surface 202A of the annular conductor portion 203 also has a second inner tapered part 21T configured so that the second bottom surface 202A is farther from the second main body surface 302 toward the first inner surface 204. The second inner inclination angle θ2 of the second inner tapered part 21T relative to a plane (XY plane) orthogonal to the first direction (Z1-Z2 direction) is 50° or less. Accordingly, it is less likely to cause locally high magnetic resistance at a specified portion in the main body portion 30. The coil component 100 thus exhibits excellent magnetic characteristics. From the viewpoint of more stably improving the characteristics of the coil component 100, the second inner inclination angle θ2 may preferably be 40° or more and 45° or less.

In this embodiment, the first inner tapered part 11T is provided on the innermost turn, namely the first inner-side turn 111, among the multiple turns included in the first spiral conductor portion 11, and the second inner tapered part 21T is provided on the innermost turn, namely the second inner-side turn 211, among the multiple turns included in the second spiral conductor portion 21. The first inner tapered part 11T may be provided over the entire first inner-side turn 111, and the second inner tapered part 21T may be provided over the entire second inner-side turn 211.

As shown in FIG. 5B, in a case where an average length of the first annular conductor portion (first spiral conductor portion 11) in the first direction (Z1-Z2 direction) is set to be a turn width t (unit: μm), an average gap distance in the first direction between a portion of the first bottom surface 201A, where the first inner tapered part 11T is not provided, and the first main body surface 301 is set to be a top-bottom thickness h (unit: μm), and an average gap distance viewed in the first direction between an outer peripheral edge and an inner peripheral edge of the first inner tapered part 11T is set to be an inner chamfer width p0 (unit: μm), it is preferable that the following expression (1) is satisfied:

$$t / h \times 25 μ m - 4.85 μ m \leq p 0 \leq t / h \times 25 μ m + 5.15 μ m . \qquad ( 1 )$$

By satisfying the above expression (1) with the thickness t, the top-bottom thickness h, and the inner chamfer width p0, the comprehensive characteristic L×Isat/DCR tends to increase. The derivation of the above expression (1) will be described later.

In the first annular conductor portion (first spiral conductor portion 11), when t/h is defined as the first ratio, if the first ratio is less than 1.0, p0 may be 10 μm or more and 20 μm or less; if the first ratio is 1.0 or more and less than 1.5, p0 may be 25 μm or more and 35 μm or less; and when the first ratio is 1.5 or greater, p0 may be 45 μm or more and 55 μm or less. When the first ratio satisfies the above relationship, the comprehensive characteristic Lx Isat/DCR tends to be high.

The end part 12 of the first spiral conductor portion 11 and the end part 22 of the second spiral conductor portion 21 are electrically connected via a via member VP. Starting from the connection point to the via member VP, the first spiral conductor portion 11 and the second spiral conductor portion 21 are wound in opposite directions. The via member VP may be composed of the same conductor as the coil conductor portion 20. In a specific example, the via member VP is manufactured together with the first spiral conductor portion 11 and the second spiral conductor portion 21 in the same manufacturing process. In this case, the via member VP is integrated with the end part 12 of the first spiral conductor portion 11 and the end part 22 of the second spiral conductor portion 21.

As described above, the first lead conductor part 14 is connected to the end part 13 of the first spiral conductor portion 11 as a part of the first coil conductor portion 201, and the second lead conductor portion 24 is connected to the end part 23 of the second spiral conductor portion 21 as a part of the second coil conductor portion 202. Therefore, the end part 13 of the first spiral conductor section 11 is, in essence, an interface with the first lead conductor part 14, and the end part 23 of the second spiral conductor section 21 is, in essence, an interface with the second lead conductor part 24. In a specific example, the first lead conductor part 14 and the second lead conductor part 24 are both manufactured in the process of manufacturing the first spiral conductor portion 11 and the second spiral conductor portion 21. In this case, the first lead conductor part 14 has a portion integrally formed without a boundary with the end part 13 of the first spiral conductor portion 11, and the second lead conductor part 24 has a portion integrally formed without a boundary with the end part 23 of the second spiral conductor portion 21.

In other words, in this embodiment, the coil conductor portion 20 comprises a first coil conductor portion 201 having a first spiral conductor portion 11 and a first lead conductor part 14, a second coil conductor portion 202 having a second spiral conductor portion 21 and a second lead conductor part 24, and a via member VP. These are manufactured to have an integrated portion (specifically, a portion composed of the first conductive material) formed through a common manufacturing process.

In this embodiment, as shown in FIG. 5A, from a perspective of ensuring proper insulation between the first spiral conductor portion 11 and the second spiral conductor portion 21, a first insulator portion 90 is provided. The material constituting the first insulator portion 90 is not limited as long as it possesses appropriate insulating properties. The first insulator portion 90 preferable has a volume resistivity measured according to ASTM D257 being 1.0×10¹⁴ Ω·cm or more. This volume resistivity is more preferably 1.0×10¹⁵ Ω·cm or more, and even more preferably 1.0×10¹⁶ Ω·cm or more. The upper limit of the volume resistivity is not particularly limited. The volume resistivity may be 1.0×10²⁰ Ω·cm or less. In addition, it is preferable that the first insulator portion 90 has excellent dielectric properties, and specifically, in some cases, it is preferable that the relative dielectric constant at 60 Hz measured according to ASTM D150 is 4.0 or less. The relative dielectric constant of the first insulator portion 90 is, more preferably, 3.5 or less, even more preferably, 3.0 or less. The lower limit of the relative dielectric constant is not particularly limited. The relative dielectric constant may be 1.0 or more. The method for measuring the volume resistivity and the relative dielectric constant of the first insulator portion 90 is not limited as long as the results show equivalent effects to those determined according to the above-mentioned ASTM D257 and ASTM D150. For example, a measurement sample is additionally prepared by formulating a material equivalent to the first insulator portion 90 with the dimensions required for measurement, and the constituent materials are identified using analytical techniques such as component analysis and FT-IR with the measurement sample. Then the features of the material, such as volume resistivity, are evaluated.

The material constituting the first insulator portion 90 may be formed of an organic material, an inorganic material, or a composite material of an organic material and an inorganic material. In a case where the first insulating portion 90 is formed of a composite material, the inorganic material may have a particulate shape and may be dispersed in a matrix formed of the organic material. Specific examples of the organic material include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, and polytetrafluoroethylene resin. Specific examples of the inorganic material, particularly the inorganic material in the composite material, include oxides, carbides, nitrides, and inorganic salts. For example, oxides include silica, alumina, and zirconia. Further, examples of carbides and nitrides include silicon carbide and boron nitride, respectively. Examples of inorganic salts include minerals such as wollastonite, kaolin, and mica. Among these, oxide-based materials such as oxides, silicates, and phosphates are preferable in terms of cost and insulating properties. For example, it is preferable that the inorganic material contains at least one selected from the group consisting of silicon (Si), phosphorus (P), boron (B), and calcium (Ca).

The coil member 10 according to this embodiment has a second insulator portion 80 provided on at least a portion of the surface of the first coil conductor portion 201 and the surface of the second coil conductor portion 202.

The material constituting the second insulator portion 80 is not limited as long as it has appropriate insulating properties. The second insulator portion 80 may be formed of the same material as the first insulator portion 90 or may be formed of a different material from the first insulator portion 90. In the present embodiment, it is preferable that the second insulator portion 80 is thermoplastic. As a thermoplastic material, it is particularly preferable that the second insulator portion 80 includes a thermoplastic resin containing a parylene-based polymer. Other examples of thermoplastic resins include polyethylene, polypropylene, polyamide, polyester, polyamide-imide, polyimide, polysulfone, polycarbonate, liquid crystal polymer, polyvinylidene fluoride, and polytetrafluoroethylene. It is preferable that the second insulator portion 80 as a whole exhibits thermoplasticity, and in addition to the above thermoplastic resin, it may further contain, for example, inorganic insulating particles.

It is preferable that the second insulator portion 80 exhibits excellent insulating properties, and specifically, the volume resistivity obtained according to ASTM D257 may preferably be 1.0×10¹⁴ Ω·cm or more. More preferably, the volume resistivity is 1.0×10¹⁵ Ω·cm or more, and still more preferably, 1.0×10¹⁶ Ω·cm or more. The upper limit of the volume resistivity is not particularly limited, and may be 1.0×10²⁰ Ω·cm or less. It is also preferable that the second insulator portion 80 exhibits excellent dielectric properties, and specifically, the relative dielectric constant at 60 Hz obtained according to ASTM D150 may preferably be 4.0 or less. More preferably, the relative dielectric constant is 3.5 or less, and still more preferably, 3.0 or less. The lower limit of the relative dielectric constant is not particularly limited, and may be 1.0 or more. For measurement of the volume resistivity and the relative dielectric constant, a material corresponding to the second insulator portion 80 prepared separately is processed to dimensions required for measurement and used. The material corresponding to the second insulator portion 80 can be identified, similarly to the case of the first insulator portion 90, for example, through component analysis or analytical techniques such as FT-IR.

The structure of the magnetic powder is not limited. This structure may include a crystalline phase or an amorphous phase. Herein, a crystalline material is defined as a material formed of a crystalline phase, an amorphous material is defined as a material formed of an amorphous phase, and a composite material is defined as a material including a crystalline material and an amorphous material. In a situation that the diffraction spectrum obtained by a general X-ray diffraction method includes a sharp diffraction peak that can identify the type of crystalline phase, the material includes a crystalline phase. On the other hand, in the situation that the diffraction spectrum obtained by a general X-ray diffraction method includes a broad peak indicating an amorphous phase, the material includes an amorphous phase. If the DSC curve obtained by differential thermal analysis includes a peak indicating crystallization, i.e., heat generation associated with a phase change from an amorphous phase to a crystalline phase, the material includes an amorphous phase.

The material system of the magnetic powder is not limited. Specific examples of the crystalline material include Fe—Si—Cr based alloys, Fe—Ni based alloys, Fe—Co based alloys, Fe—V based alloys, Fe—Al based alloys, Fe—Si based alloys, Fe—Si—Al based alloys, iron only, and ferrite. It is preferable to use carbonyl iron powder as iron-only powder. Specific examples of the amorphous material include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. If the magnetic powder is metal powder containing Fe, the synergistic effect on improvement of magnetic properties is particularly significant.

The chemical composition of the magnetic powder is not limited. For example, the Fe—Si—Cr based alloy may be composed of 1.0-10.0 mass % Si, 1.0-10.0 mass % Cr, and the remainder composed of Fe and impurities. Also, for example, the Fe—Ni based alloy may be composed of 1.0-99.0 mass % Ni, and the remainder composed of Fe and impurities. Furthermore, for example, the Fe—P—C based alloy may be composed of 1.0-13.0 atom % P, 1.0-13.0 atom % C, Fe, and impurities. The Fe—P—C based alloy may contain one or more optional elements selected from the group consisting of Ni, Sn, Cr, B, and Si. In this case, for example, the amount of Ni may be 0 to 10.0 atomic %, the amount of Sn may be 0 to 3.0 atom %, the amount of Cr may be 0 to 6.0 atom %, the amount of B may be 0 to 9.0 atom %, and the amount of Si may be 0 to 7.0 atom. The amount of Fe is preferably 65 atom % or more. Also, for example, the Fe—Si—B—Nb—Cu based alloy may be composed of 1.0 to 16.0 atom % Si, 1.0 to 15.0 atom % B, 0.50 to 5.0 atom % Nb, 0.50 to 5.0 atom % Cu, and the balance consisting of Fe and impurities. In this case, the amount of Fe is preferably 65 atom % or more.

The shape of the magnetic powder is not limited. The magnetic powder may be spherical, elliptical, scaly, or of an irregular shape. The manufacturing method for rendering these shapes is also not limited.

The particle size distribution of the magnetic powder is not limited. The particle size distribution of the magnetic powder can be obtained, for example, by analyzing an image (secondary electron image), which is an image of a cut surface of the main body portion 30 obtained with a scanning electron microscope. For example, the average equivalent circular diameter (ECD) of the magnetic powder may be 0.50 to 50.0 μm. The distribution of the equivalent circular diameter (ECD) may include multiple peaks.

The magnetic powder may be subjected to a surface insulating treatment. Provided that the magnetic powder is subjected to a surface insulating treatment, the insulation resistance of the main body portion 30 is improved. There is no limitation on the type of surface insulating treatment applied to the magnetic powder. Examples include phosphoric acid treatment, phosphate treatment, and oxidation treatment. The magnetic powder may have an insulating coating on the surface of the magnetic particles. This insulating coating may contain at least one selected from a group consisting of Si, P, and B, and O (oxygen).

The magnetic powder may be a mixed material in which multiple powder materials are mixed. This magnetic powder is preferably a ferromagnetic material, and more preferably a soft magnetic material.

The magnetic powder may be a mixed material in which multiple powder materials are mixed. This magnetic powder is preferably a ferromagnetic material, and more preferably a soft magnetic material.

The main body portion 30 may further include an optional auxiliary material. The optional auxiliary material is, for example, a binder material or a modifier. The binder material bonds particles such as magnetic powder contained in the main body portion 30 together. This binder material is preferably an insulating material to impart insulation resistance to the main body portion 30.

The binding component may be an organic material or an inorganic material. The organic material may be a resin material. Examples of the resin material include acrylic resin, silicone resin, epoxy resin, phenol resin, urea resin, melamine resin, and polyester resin. The inorganic material may be a glass-based material such as water glass. The binding material may be a product of a reaction such as thermal decomposition, or may be a mixture of multiple materials.

The modifier, for example, improves the mobility of the powder or adjusts the curing speed of the binder material. The modifier may be a glass-based material.

As shown in FIG. 2, the outermost (X2 side in X1-X2 direction) end face (first lead conductor portion end face 14E) of the first lead conductor portion 14 and the outermost (X1 side in X1-X2 direction) end face of the second lead conductor portion 24 (second lead conductor portion end face 24E), which are located at a pair of ends of the coil member 10, are exposed from side surfaces aligned in the X1-X2 direction in the main body portion 30. A first external electrode 41, which is one of the pair of external electrodes, is provided to be in electric contact with the exposed first lead conductor portion end face 14E, and a second external electrode 42, which is the other of the pair of external electrodes, is provided to be in electric contact with the exposed second lead conductor portion end face 24E.

The first external electrode 41 includes a side portion 41a that covers the side surface on the X2 side in the X1-X2 direction of the main body portion 30, and a bottom portion 41b that is provided so as to cover a part of the bottom surface of the main body portion 30 (the surface on the Z2 side in the Z1-Z2 direction, which serves as a mounting surface during use). The second external electrode 42 includes a side portion 42a that covers the side surface on the X1 side in the X1-X2 direction of the main body portion 30, and a bottom portion 42b that is provided so as to cover a part of the bottom surface while being spaced apart from the bottom portion 41b on the bottom surface of the main body portion 30.

The positions of the first external electrode 41 and the second external electrode 42 are not limited to the positions described above. The first external electrode 41 and the second external electrode 42 may also be formed to cover partially the upper surface of the main body portion 30. The first external electrode 41 and the second terminal member 42 may also be provided on only partially the bottom surface of the main body portion 30. In this case, the coil conductor portion 20 may include a connecting conductor (not shown), which connects the two ends (first lead conductor portion end face 14E and second lead conductor portion end face 24E) of the coil member 10 to the bottom surface of the main body portion 30 through the inside of the main body portion 30. In this case, the two ends (first lead conductor portion end face 14E and second lead conductor portion end face 24E) of the coil member 10 may not be exposed from the side surface of the main body portion 30, while the connecting conductor may be exposed from the bottom surface of the main body portion 30.

The material and configuration of the first external electrode 41 and the second t external electrode 42 are not limited as long as they have appropriate conductivity. One non-limiting example of the first external electrode 41 and the second external electrode 42 is a layer having a structure of Cu plating/Ni plating/Sn plating from the side proximal to the surface of the main body portion 30. The first external electrode 41 and the second external electrode 42 may be composed of a coated electrode, in which a conductive material such as silver is dispersed in a resin or the like. The first external electrode 41 and the second external electrode 42 may also be a combination of plated layer and coated electrode.

The upper surface of the main body portion 30 (surface on Z1 side in Z1-Z2 direction) and the side surfaces in the Y1-Y2 direction are each provided with an insulating outer cover 50, 60. An insulating outer cover may also be provided on a portion of the bottom surface of the main body portion 30, where the bottom surface portions 41b and 42b are not provided. Furthermore, the coil component 100 may not be provided with the outer cover 50, 60. The outer covers 50 and 60 can be formed at any position on the surface of the main body portion 30 depending on practical requirements.

### Second Embodiment

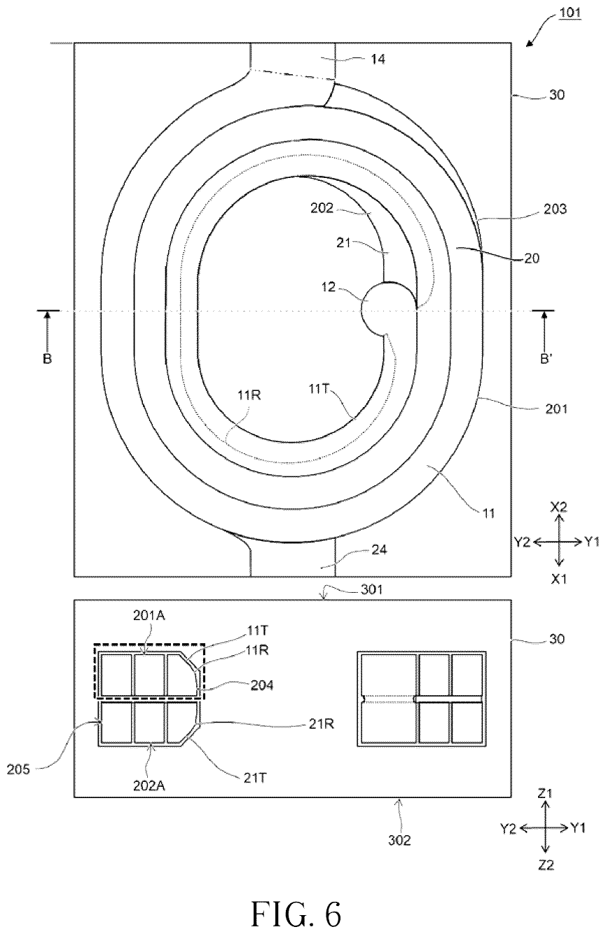

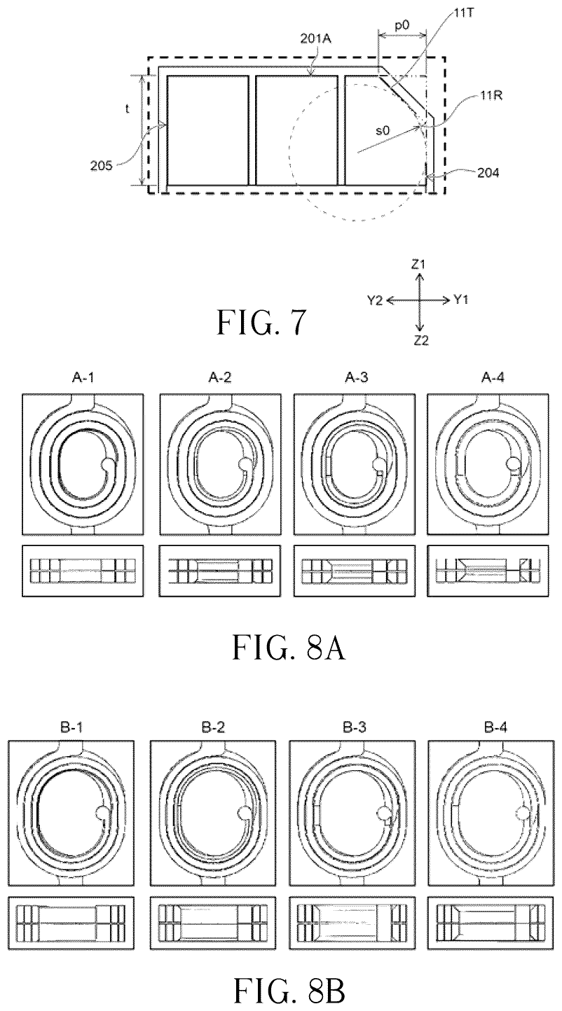

FIG. 6 is a plan view and a YZ cross-sectional view taken along line B-B′ of the plan view, illustrating the configuration of a coil component according to a second embodiment of the present invention. FIG. 7 is an enlarged view of the region enclosed by the thick dotted line in the YZ cross-sectional view of FIG. 6.

The coil component 101 according to the second embodiment of the present invention shares the same configuration as the coil component 100 according to the first embodiment of the present invention, except for the detailed structure around the first inner tapered part 11T and the second inner tapered part 21T. Therefore, only the parts with different configurations will be described, and the description of other configurations will be omitted.

The annular conductor portion 203 provided in the coil component 101 according to the present embodiment has a first inner corner part 11R that connects the first inner surface 204 and the first inner tapered part 11T with a continuous surface, and a second inner corner part 21R that connects the first inner surface 204 and the second inner tapered part 21T with a continuous surface. By having the first inner corner part 11R, the degree of bending of a magnetic path passing through the main body portion 30 in the vicinity of a region, where the first inner surface 204 and the first inner tapered part 11T are connected, is alleviated so that it is less likely for the magnetic resistance to locally increase in this region. Therefore, it is possible to enhance the improvement on the characteristics of the coil component 100.

When the annular conductor portion 203 is cut along a first cross section orthogonal to the current path and extending in the first direction, a cross-sectional line, by which the first inner corner portion 11R is drawn on the first cross section, may have a shape approximated by an arc with a radius s0 (unit: μm). In this case, so may satisfy 25 μm≤s0≤50 μm, and s0/t, obtained by dividing the radius so by the turn thickness t (the average length in the first direction of the first annular conductor portion, i.e., the first spiral conductor portion 11), may be 0.1 or more.

### (Simulation)

Hereinafter, simulation performed to derive the above expression (1) is described.

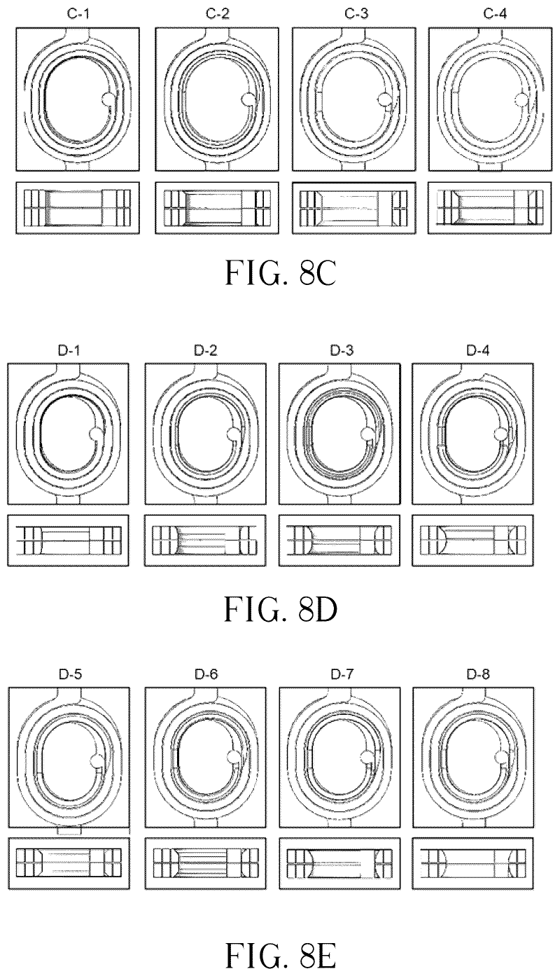

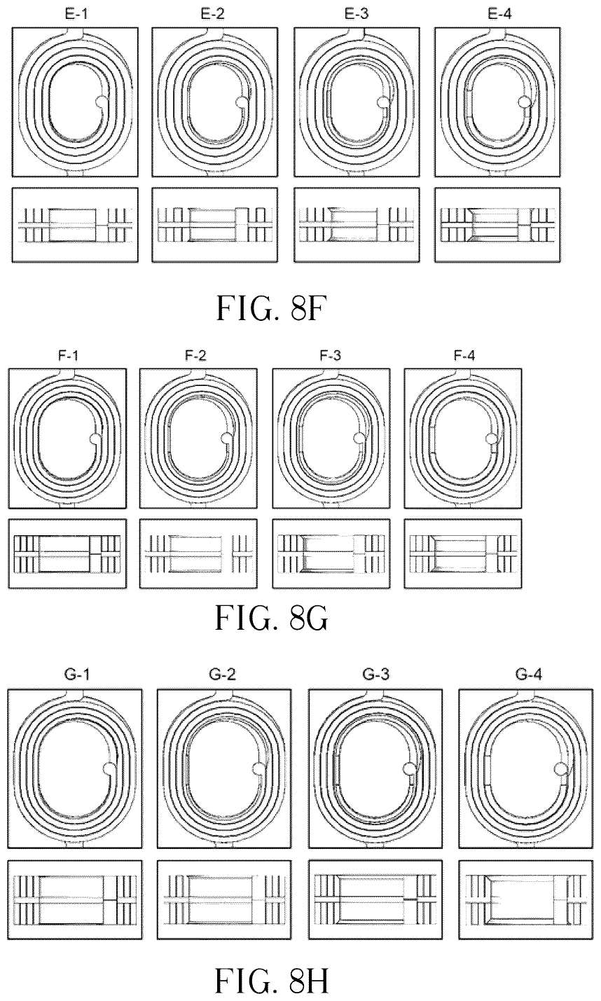

Simulation is performed on the coil components 100 and 101 having the shapes shown in Tables 1 to 3. In the tables, t, p0, h, and so are as defined above. As shown in FIG. 5B, W represents the width (unit: μm) of a turn of the first spiral conductor portion 11 in a direction orthogonal to the first direction (Z1-Z2 direction), and Gap represents the gap (unit: μm) between adjacent turns in the first spiral conductor portion 11. The first spiral conductor portion 11 is not provided with the first insulator portion 90 or the second insulator portion 80, and the shape of the main body portion 30 is 1.25 mm×1.05 mm× height 0.45 mm. An outline of the shapes of these coil components 100 and 101 is shown in FIG. 8A to FIG. 8H. As shown in Tables 1 and 3 and FIG. 8A to FIG. 8C and FIG. 8F to FIG. 8H, the series from series A to series C and from series E to series G are coil components 100 according to the first embodiment, which do not have the first inner corner part 11R (however, numbers A-0, B-0, C-0, E-0, F-0, and G-0 are references that do not have the first inner tapered part 11T). Within each series, the length of the first inner tapered part 11T (inner chamfer width p0) differs. As shown in Table 2 and FIG. 8D and FIG. 8E, series D is related to coil components 101 according to the second embodiment, which have the first inner corner part 11R except for series item D-0. In this series, the inner chamfer width p0 and the radius so of the first inner corner part 11R differ. For simplifying the simulation model, none of the coil components 100 and 101 have the second insulator portion 80.

TABLE 1

| | t | W | Gap | P0 | h | S0 | |
|---|---|---|---|---|---|---|---|
| No. | [μm] | | | | | | tanθ1 |
| A-0 | 100 | 80 | 8 | 0 | 119 | 0 | 0 |
| A-1 | | | | 15 | | | 1 |
| A-2 | | | | 30 | | | |
| A-3 | | | | 50 | | | |
| A-4 | | | | 70 | | | |
| B-0 | 120 | 68 | | 0 | 99 | | 0 |
| B-1 | | | | 15 | | | 1 |
| B-2 | | | | 30 | | | |
| B-3 | | | | 50 | | | |
| B-4 | | | | 68 | | | |
| C-0 | 150 | 56 | | 0 | 69 | | 0 |
| C-1 | | | | 15 | | | 1 |
| C-2 | | | | 30 | | | |
| C-3 | | | | 50 | | | |
| C-4 | | | | 56 | | | |

TABLE 2

| | t | W | Gap | P0 | h | S0 | |
|---|---|---|---|---|---|---|---|
| No. | [μm] | | | | | | tanθ1 |
| D-0 | 120 | 68 | 8 | 0 | 99 | 0 | 0 |
| D-1 | | | | 15 | | 100 | 1 |
| D-2 | | | | 30 | | | |
| D-3 | | | | 50 | | | |
| D-4 | | | | 68 | | | |
| D-5 | | | | 50 | | 25 | |
| D-6 | | | | | | 50 | |
| D-7 | | | | | | 150 | |
| D-8 | | | | | | 170 | |

TABLE 3

| | t | W | Gap | P0 | h | S0 | |
|---|---|---|---|---|---|---|---|
| No. | [μm] | | | | | | tanθ1 |
| E-1 | 180 | 95 | 8 | 15 | 260 | 0 | 1 |
| E-2 | | | | 30 | | | |
| E-3 | | | | 50 | | | |
| E-4 | | | | 70 | | | |
| F-1 | 220 | 80 | | 15 | 220 | | |
| F-2 | | | | 30 | | | |
| F-3 | | | | 50 | | | |
| F-4 | | | | 70 | | | |
| G-1 | 260 | 70 | | 15 | 180 | | |
| G-2 | | | | 30 | | | |
| G-3 | | | | 50 | | | |
| G-4 | | | | 70 | | | |

By simulation, the following characteristics were obtained:
Self-inductance L (unit: μH)
DC resistance DCR (unit: mΩ)
DC superimposed rated current Isat (unit: A)

Based on the desired characteristics, the following comprehensive characteristics are calculated: L/DCR (unit: mHΩ⁻¹), L×Isat (unit: ρHΩ), and the comprehensive characteristic Lx Isat/DCR (unit: mHΩ⁻¹). The results obtained for respective characteristics are shown in Table 4 through Table 6.

TABLE 4

| | L | DCR | Isat | L/DCR | L*Isat | L*Isat/DCR |
|---|---|---|---|---|---|---|
| No. | [μH] | [mΩ] | [A] | [mHΩ⁻¹] | [μHA] | [mHAΩ⁻¹] |
| A-0 | 0.343 | 29.13 | 3.489 | 0.01177 | 1.19673 | 0.04108 |
| A-1 | 0.347 | 29.28 | 3.463 | 0.01185 | 1.20166 | 0.04104 |
| A-2 | 0.354 | 29.67 | 3.428 | 0.01193 | 1.21351 | 0.04090 |
| A-3 | 0.367 | 30.83 | 3.353 | 0.01190 | 1.23055 | 0.03991 |
| A-4 | 0.383 | 33.15 | 3.262 | 0.01155 | 1.24935 | 0.03769 |
| B-0 | 0.349 | 29.72 | 3.643 | 0.01174 | 1.27141 | 0.04278 |
| B-1 | 0.353 | 29.86 | 3.638 | 0.01182 | 1.28421 | 0.04301 |
| B-2 | 0.360 | 30.28 | 3.640 | 0.01189 | 1.31040 | 0.04328 |
| B-3 | 0.373 | 31.45 | 3.609 | 0.01186 | 1.34616 | 0.04280 |
| B-4 | 0.387 | 33.46 | 3.551 | 0.01157 | 1.37424 | 0.04107 |
| C-0 | 0.321 | 30.02 | 3.394 | 0.01069 | 1.08947 | 0.03629 |
| C-1 | 0.326 | 30.16 | 3.391 | 0.01081 | 1.10547 | 0.03665 |
| C-2 | 0.333 | 30.55 | 3.397 | 0.01090 | 1.13120 | 0.03703 |
| C-3 | 0.346 | 31.70 | 3.385 | 0.01091 | 1.17121 | 0.03695 |
| C-4 | 0.351 | 32.23 | 3.387 | 0.01089 | 1.18884 | 0.03689 |

TABLE 5

| | L | DCR | Isat | L/DCR | L*Isat | L*Isat/DCR |
|---|---|---|---|---|---|---|
| No. | [μH] | [mΩ] | [A] | [mHΩ⁻¹] | [μHA] | [mHAΩ⁻¹] |
| D-0 | 0.349 | 29.72 | 3.643 | 0.01174 | 1.27141 | 0.04278 |
| D-1 | 0.356 | 30.09 | 3.632 | 0.01183 | 1.29299 | 0.04297 |
| D-2 | 0.365 | 30.73 | 3.619 | 0.01188 | 1.32094 | 0.04299 |
| D-3 | 0.377 | 32.02 | 3.588 | 0.01177 | 1.35268 | 0.04224 |
| D-4 | 0.392 | 34.29 | 3.533 | 0.01143 | 1.38494 | 0.04039 |
| D-5 | 0.374 | 31.54 | 3.609 | 0.01186 | 1.34977 | 0.04280 |
| D-6 | 0.375 | 31.66 | 3.604 | 0.01184 | 1.35150 | 0.04269 |
| D-7 | 0.381 | 32.63 | 3.569 | 0.01168 | 1.35979 | 0.04167 |
| D-8 | 0.382 | 32.86 | 3.561 | 0.01163 | 1.36030 | 0.04140 |

TABLE 6

| | L | DCR | Isat | L/DCR | L*Isat | L*Isat/DCR |
|---|---|---|---|---|---|---|
| No. | [μH] | [mΩ] | [A] | [mHΩ⁻¹] | [μHA] | [mHAΩ⁻¹] |
| E-1 | 1.043 | 31.21 | 4.464 | 0.03342 | 4.65595 | 0.1492 |
| E-2 | 1.051 | 31.35 | 4.443 | 0.03352 | 4.66959 | 0.1490 |
| E-3 | 1.066 | 31.69 | 4.403 | 0.03364 | 4.69360 | 0.1481 |
| E-4 | 1.084 | 32.27 | 4.352 | 0.03359 | 4.71757 | 0.1462 |
| F-1 | 1.077 | 31.86 | 5.124 | 0.03380 | 5.51855 | 0.1732 |
| F-2 | 1.085 | 32.00 | 5.113 | 0.03391 | 5.54761 | 0.1734 |
| F-3 | 1.100 | 32.35 | 5.085 | 0.03400 | 5.59350 | 0.1729 |
| F-4 | 1.117 | 32.95 | 5.043 | 0.03390 | 5.63303 | 0.1710 |
| G-1 | 1.042 | 31.76 | 5.304 | 0.03281 | 5.52677 | 0.1740 |
| G-2 | 1.050 | 31.89 | 5.312 | 0.03293 | 5.57760 | 0.1749 |
| G-3 | 1.064 | 32.23 | 5.319 | 0.03301 | 5.65942 | 0.1756 |
| G-4 | 1.082 | 32.81 | 5.308 | 0.03298 | 5.74326 | 0.1750 |

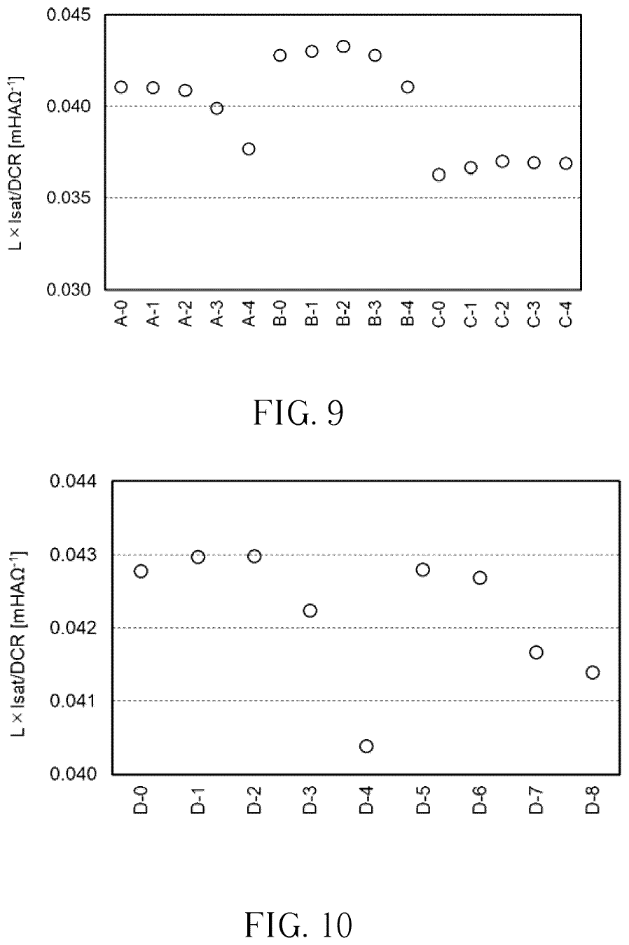

FIG. 9 is a graph of the comprehensive characteristic L×Isat/DCR for the coil components 100 of the series from series A to series C, FIG. 10 is a graph of the comprehensive characteristic L×Isat/DCR for the coil components 100 of series D, and FIG. 11 is a graph of the comprehensive characteristic L×Isat/DCR for the coil components 100 of the series from series E to series G.

As shown in FIG. 9, in each series, the comprehensive characteristic L×Isat/DCR exhibited a tendency to vary depending on the inner chamfer width p0. In series A, in which the average gap distance in the first direction (top-bottom thickness h) from the first main body surface 301 is 119 μm, the comprehensive characteristic L×Isat/DCR is generally maximized when the inner chamfer width p0 is 15 μm. In series B, in which the top-bottom thickness h is 99 μm, the comprehensive characteristic L×Isat/DCR is generally maximized when the inner chamfer width p0 is 30 μm. In series C, in which the top-bottom thickness h is 69 μm, the comprehensive characteristic L×Isat/DCR is generally maximized when the inner chamfer width p0 is 50 μm. A similar tendency is confirmed in the series from series E to series G shown in FIG. 11. That is, in series E, in which the top-bottom thickness h is 260 μm, the comprehensive characteristic L×Isat/DCR is generally maximized when the inner chamfer width p0 is 15 μm. In series F, in which the top-bottom thickness h is 220 μm, the comprehensive characteristic Lx Isat/DCR is generally maximized when the inner chamfer width p0 is 30 μm. In series G, in which the top-bottom thickness h is 180 μm, the comprehensive characteristic L×Isat/DCR is generally maximized when the inner chamfer width p0 is 50 μm.

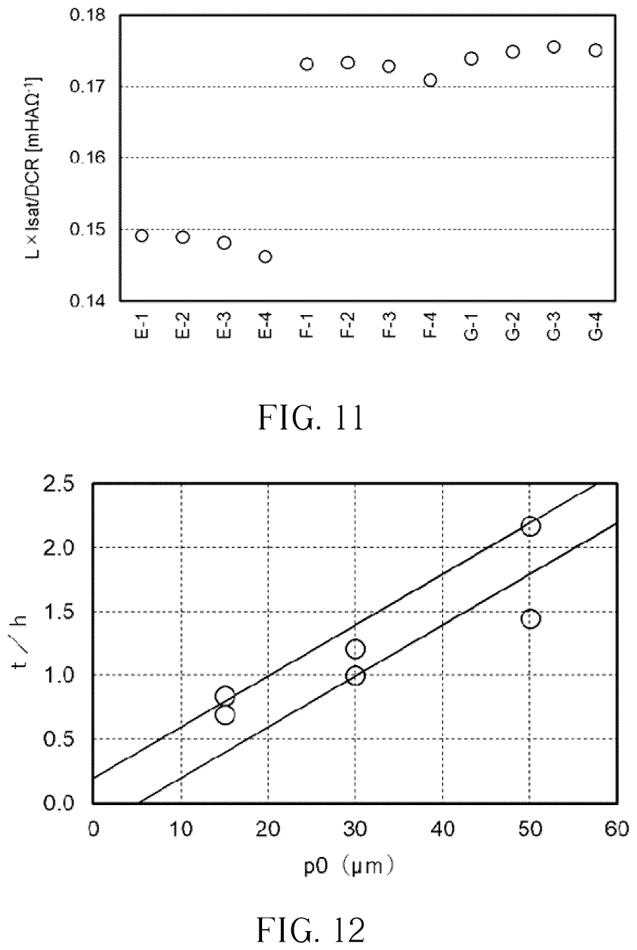

These trends can be organized by using the first ratio (t/h). As shown in FIG. 12, which is a graph showing the dependence of a first ratio (t/h) on an inner chamfer width p0. The results fall well within the range of the above expression (1). The solid lines in FIG. 12 represent p0=t/h×25 μm−4.85 μm and p0=t/h×25 μm+5.15 μm.

### Third Embodiment˜Fifth Embodiment

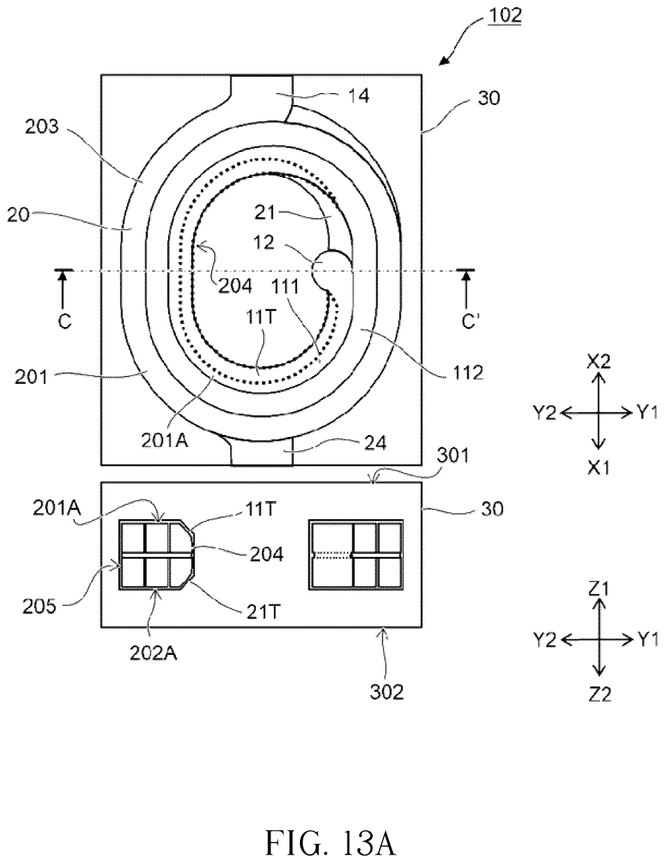

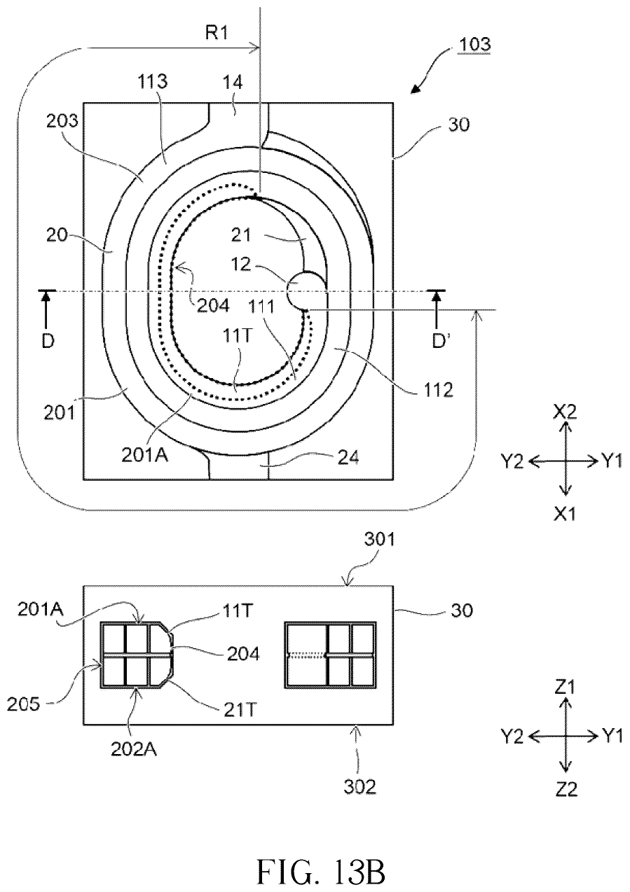

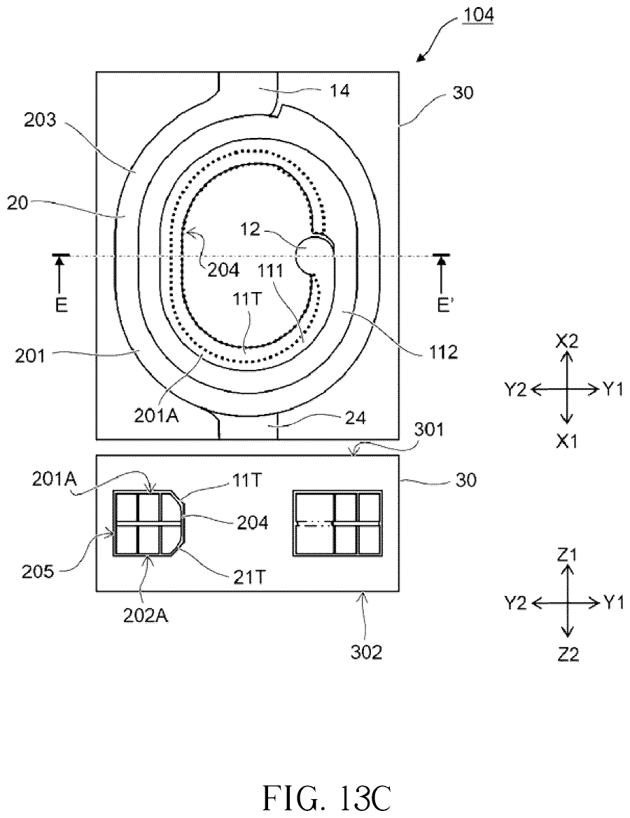

FIG. 13A is a plan view (However, only the outer edge of the main body portion 30 and the coil member 10 are shown) and a YZ cross-sectional view taken along line C-C′ of the plan view, illustrating the configuration of a coil component according to a third embodiment of the present invention. FIG. 13B is a plan view (However, only the outer edge of the main body portion 30 and the coil member 10 are shown) and a YZ cross-sectional view taken along line D-D′ of the plan view, illustrating the configuration of a coil component according to a fourth embodiment of the present invention. FIG. 13C is a plan view (However, only the outer edge of the main body portion 30 and the coil member 10 are shown) and a YZ cross-sectional view taken along line E-E′ of the plan view, illustrating the configuration of a coil component according to a fifth embodiment of the present invention. In each of these figures, the boundary between the first inner tapered part 11T and the first bottom surface 201A, as well as the boundary between the first inner tapered part 11T and the first inner surface 204, are shown with thick dotted lines for enhanced visibility.

The coil component 102 according to the third embodiment, the coil component 103 according to the fourth embodiment, and the coil component 104 according to the fifth embodiment share the same configuration as the coil component 100 according to the first embodiment, except for the structure of the portions where the first inner tapered part 11T and the second inner tapered part 21T are provided when viewed in the first direction. Therefore, only the portions having different configurations will be described, and the description of other configurations will be omitted.

When comparing the coil component 102 according to the third embodiment with the coil component 100 according to the first embodiment in terms of the first inner tapered part 11T, in the coil component 100 according to the first embodiment, the first inner tapered part 11T extends from the start position of the first inner-side turn 111 (a connecting part with the end part 12 of the first spiral conductor portion 11) to the start position of the first central turn 112 located on the outer side of the end part 12 of the first spiral conductor portion 11 (see FIG. 3).

In contrast, in the coil component 102 according to the third embodiment, as shown in FIG. 13A, the first inner tapered part 11T is configured to start from the start position of the first inner-side turn 111, which is common to the aforementioned, but the first inner tapered part 11T disappears before reaching the start position of the first central turn 112. That is, in the coil component 102 according to the third embodiment, the first inner tapered part 11T is provided only on the innermost turn (the first inner-side turn 111). In addition, the first inner-side turn 111 has a portion where the first inner tapered part 11T is not provided.

When comparing the coil component 103 according to the fourth embodiment with the coil component 100 according to the first embodiment in terms of the first inner tapered part 11T, in the coil component 100 according to the first embodiment, the first inner tapered part 11T extends from the start position of the first inner-side turn 111 (the connecting part with the end part 12 of the first spiral conductor portion 11) to the start position of the first central turn 112 located on the outer side of the end part 12 of the first spiral conductor portion 11 (see FIG. 3).

In contrast, in the coil component 103 according to the fourth embodiment, as shown in FIG. 13B, the first inner tapered part 11T is configured to start from the start position of the first inner-side turn 111, which is common to the aforementioned, but in the first inner-side turn 111, the first inner circumferential tapered portion 11T disappears at a position corresponding to the end position of the first outer-side turn 113. That is, in the coil component 103 according to the fourth embodiment, the first inner tapered part 11T is provided only in the portion of the first inner-side turn 111 where the first central turn 112 and the first outer-side turn 113 are arranged. In other words, in the coil component 103 according to the fourth embodiment, the first inner tapered part 11T is provided in at least a part, specifically the entirety, of a first more-turn region R1 of the first spiral conductor portion 11, in which the number of turns is relatively large.

Based on the difference in the area of the current path, locally, the magnetic flux density around the first more-turn region R1 having three turns is higher than the magnetic flux density around another region other than the first more-turn region R1, which has two turns. Therefore, in the magnetic path surrounding the coil member 10, the amount of change in magnetic flux density in the region, where the magnetic path transitions from a magnetic path along the first direction to a magnetic path along an in-plane direction orthogonal to the first direction, and the region, where the magnetic path transitions oppositely, is greater around the first more-turn region R1. Accordingly, by providing the first inner tapered part 11T in the first more-turn region R1 of the first inner-side turn 111, the magnetic resistance of the magnetic path can be efficiently reduced, thereby improving the characteristics of the coil component 100. On the other hand, by remaining a region other than the first more-turn region R1, where the first inner tapered part 11T is not provided, the DC resistance DCR of the coil component 100 can be kept low.

When comparing the coil component 104 according to the fifth embodiment with the coil component 100 according to the first embodiment, in the coil component 100 according to the first embodiment, since the width of the first inner-side turn 111 does not change, when viewed from the Z1 side in the Z1-Z2 direction, there is a region where the second spiral conductor portion 21 (when only the coil conductor portion is shown) is visible on the X2 side in the X1-X2 direction of the end part 12 of the first spiral conductor portion 11 (see FIG. 3). In addition, the first inner-side tapered part 11T extends from the start position of the first inner-side turn 111 to the start position of the first central turn 112 located on the outer side of the end part 12 of the first spiral conductor portion 11 (see FIG. 3).

In contrast, in the coil component 104 according to the fifth embodiment, as shown in FIG. 13C, the width of the first inner-side turn 111 is widened on the X2 side in the X1-X2 direction of the end part 12 of the first spiral conductor portion 11 when viewed from the Z1 side in the Z1-Z2 direction, and there is no region where the second spiral conductor portion 21 is visible. The first inner tapered part 11T is configured to start from the start position of the first inner-side turn 111, which is common to the aforementioned, but extends to the portion where the width of the first inner-side turn 111 is widened. That is, in the coil component 104 according to the fifth embodiment, in the inner peripheral edge of the first spiral conductor portion 11, the first inner tapered part 11T is provided on a portion other than the end part 12 of the first spiral conductor portion 11. In other words, in the coil component 104 according to the fifth embodiment, the first inner tapered part 11T is provided over the entire inner side of the innermost turn (the first inner-side turn 111) of the first spiral conductor portion 11.

### Sixth Embodiment

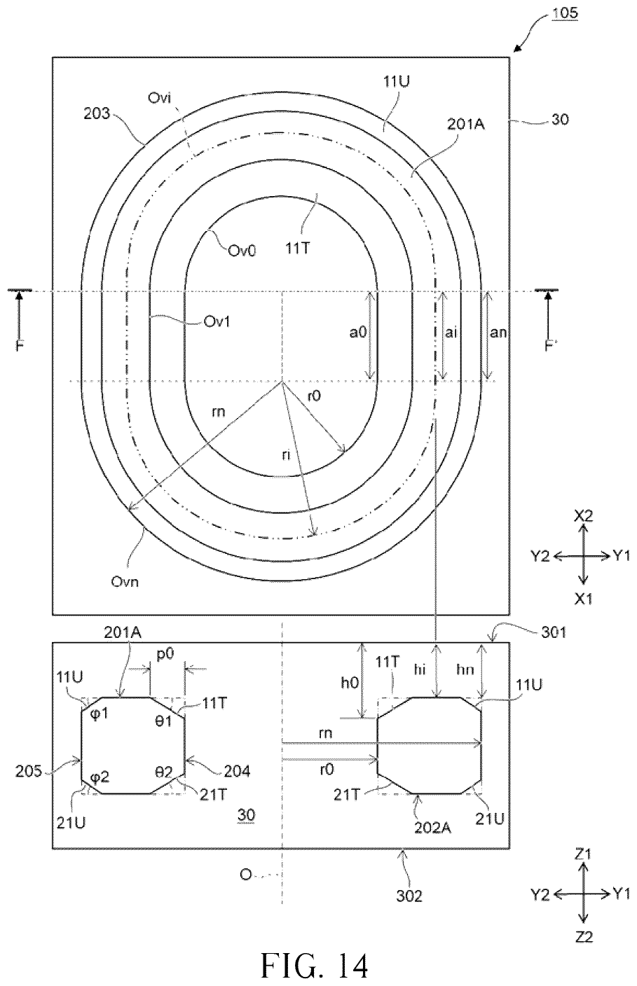

FIG. 14 is a plan view (However, only the outer edge of the main body portion 30 and the annular conductor portion 203 are shown) and a YZ cross-sectional view taken along line F-F′ of the plan view, illustrating the structure of a coil component according to a sixth embodiment of the present invention. In FIG. 14, a more conceptualized shape compared to FIG. 6 is illustrated. For example, only the annular conductor portion 203 of the coil member 10 is shown in an approximate shape, and the end part 12 of the first spiral conductor portion 11 is omitted from the illustration.

The coil component 105 according to the sixth embodiment shares the same configuration as the coil component 100 according to the first embodiment of the present invention, except that a tapered part is also provided on the outer side of the annular conductor portion 203. Therefore, only the parts with different configurations will be described, and the description of other configurations will be omitted.

The coil component 105 according to the sixth embodiment has a first outer tapered part 11U on the first bottom surface 201A, which becomes farther from the first main body surface 301 as it approaches the first outer surface 205. The first outer inclination angle φ1 of the first outer tapered part 11U with respect to a plane orthogonal to the first direction (XY plane) is 50° or less. The coil component 105 also has a second outer tapered part 210 on the second bottom surface 202A, which becomes farther from the second main body surface 302 toward the first outer surface 205. The second outer inclination angle o2 of the second outer tapered part 21U with respect to a plane orthogonal to the first direction (XY plane) is 50° or less.

By providing the first outer tapered part 11U and the second outer tapered part 21U, in a magnetic path that extends from a portion located outside the first outer surface 205 in the main body portion 30 to a portion located outside the first bottom surface 201A or the second bottom surface 202A in the main body portion 30, or in a magnetic path in the opposite direction, it becomes less likely for the magnetic resistance to locally increase, thereby making it easier to improve the characteristics of the coil component 105.

### Seventh Embodiment˜Tenth Embodiment

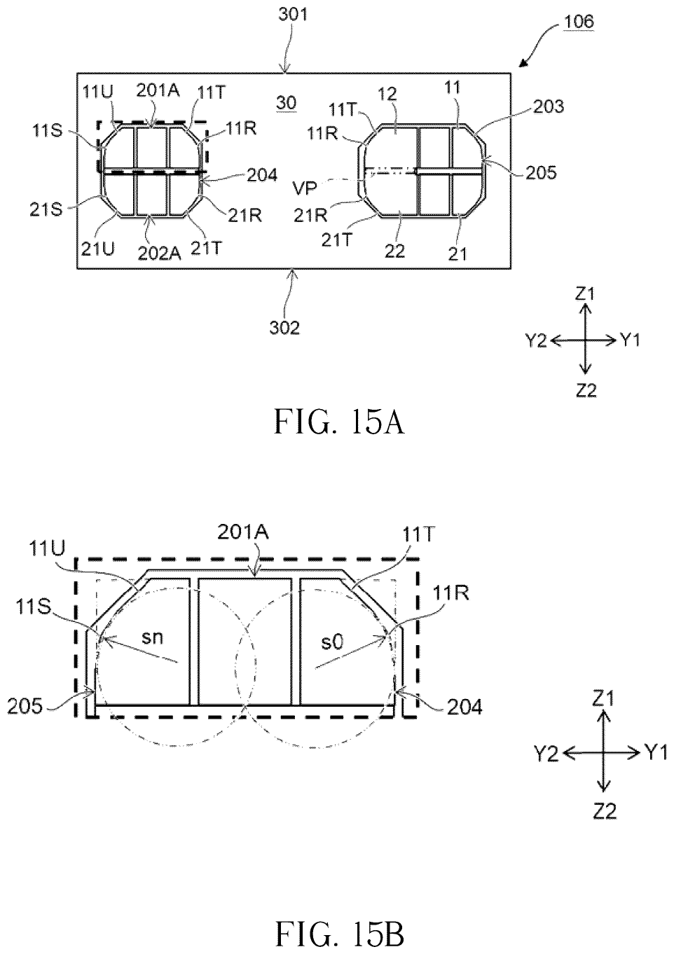

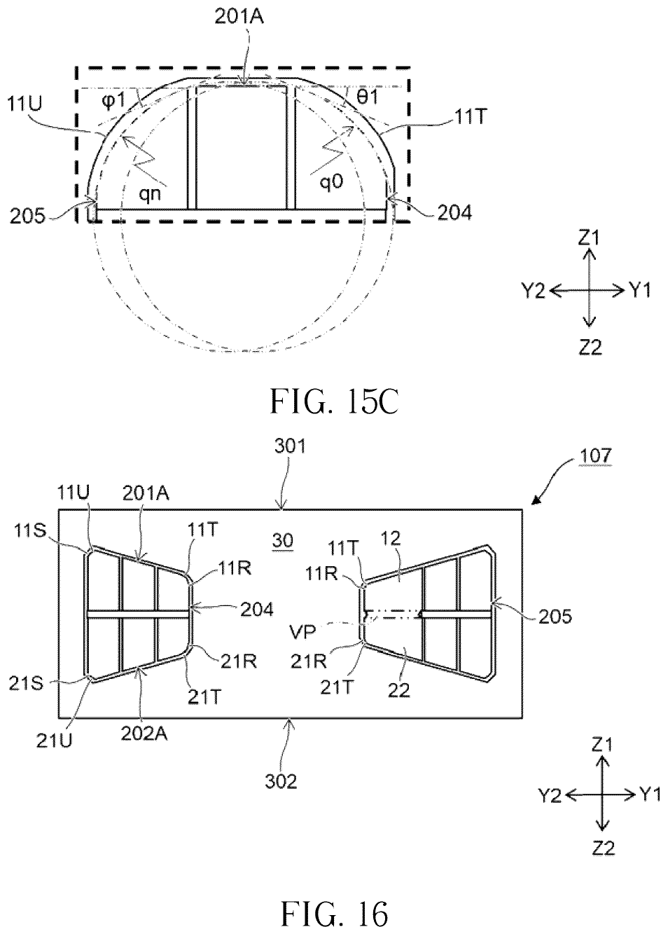

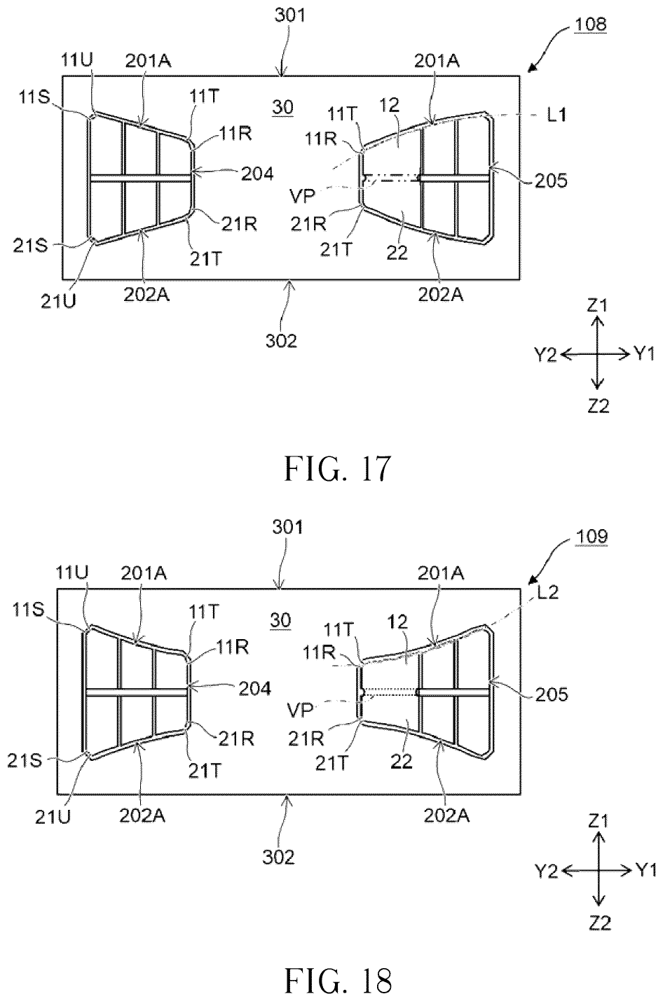

FIG. 15A is a YZ cross-sectional view illustrating the structure of a coil component according to a seventh embodiment of the present invention. FIG. 15B is an enlarged view of the region enclosed by the bold broken line in FIG. 15A. FIG. 15C is a diagram illustrating the structure of a coil component according to a modified example of the seventh embodiment, showing the same range as FIG. 15B. FIG. 16 is a YZ cross-sectional view illustrating the structure of a coil component according to an eighth embodiment of the present invention. FIG. 17 is a YZ cross-sectional view illustrating the structure of a coil component according to a ninth embodiment of the present invention. FIG. 18 is a YZ cross-sectional view illustrating the structure of a coil component according to a tenth embodiment of the present invention.

The coil component 106 according to the seventh embodiment shares the same configuration as the coil component 105 according to the sixth embodiment of the present invention, except for the detailed structure near the tapered part. Therefore, only the parts with different configurations will be described, and the description of other configurations will be omitted.

The first annular conductor portion (first spiral conductor portion 11) of the coil component 106 according to the seventh embodiment includes a first inner corner part 11R, which connects the first inner surface 204 and the first inner tapered part 11T with a continuous surface, and a first outer corner part 11S, which connects the first outer surface 205 and the first outer tapered part 11U with a continuous surface.

By having the first inner corner part 11R, similarly to the coil component 101 according to the second embodiment, the degree of bending of a magnetic path passing through the main body portion 30 in the vicinity of a region, where the first inner surface 204 and the first inner tapered part 11T are connected, is alleviated so that it is less likely for the magnetic resistance to locally increase in this region. Further, by having the first outer corner part 11S, the degree of bending of a magnetic path passing through the main body portion 30 in the vicinity of a region, where the first outer surface 205 and the first outer tapered part 11U are connected, is alleviated so that it is less likely for the magnetic resistance to locally increase in this region. Therefore, it is possible to enhance the improvement on the characteristics of the coil component 100.

In a specific example, when cut along a first cross section (a cross section orthogonal to the current path of the annular conductor portion 203 and extending in the first direction), as shown in FIG. 15B, a cross-sectional line, by which the first inner corner portion 11R is drawn on the first cross section, may have a shape approximated by an arc with a radius s0 (unit: μm), and a cross-sectional line, where the first outer corner portion 11S is drawn on the first cross section, may have a shape approximated by an arc with a radius sn (unit: μm). The first cross section is generally a plane containing the width direction of the turn.

As a preferred example, sn/s0 may be 0.8 or more and 1.2 or less. When sn/s0 falls within this range, it becomes less likely for a local increase in magnetic resistance to occur in the magnetic path surrounding the first annular conductor portion (first spiral conductor portion 11).

The second annular conductor portion (second spiral conductor portion 21) of the coil component 106 according to the seventh embodiment includes, similarly to the first annular conductor portion (first spiral conductor portion 11), a second inner corner part 21R and a second outer corner part 21S. In a specific example, when cut along the first cross section, as shown in FIG. 15B, a cross-sectional line, by which the second inner corner portion 21R is drawn on the first cross section, may have a shape approximated by an arc, and a cross-sectional line, by which the second outer corner portion 21S is drawn on the first cross section, may also have a shape approximated by an arc. The radii of these arcs may have the same relationship as in the example of the first annular conductor portion (first spiral conductor portion 11).

The coil component 106 according to the seventh embodiment differs from the coil component 101 according to the second embodiment in that a first inner tapered part 11T and a first inner corner part 11R are also provided at the end part 12 of the first spiral conductor portion 11, and a second inner tapered part 21T and a second inner corner part 21R are also provided at the end part 22 of the second spiral conductor portion 21. By providing the tapered parts and the like at the ends located on the inner peripheral edges of the spiral conductor portions in this manner, a local increase in magnetic resistance is less likely to occur in a magnetic path that circulates around an annular conductor portion 203 when current flows through the coil component.

In the coil component according to the seventh embodiment, the first inner tapered part 11T and the first outer tapered part 110 of the first annular conductor portion (first spiral conductor portion 11) of the coil component 106, as shown in FIG. 15C, may have a shape approximating an arc, which is drawn on the first cross section by the cross-sectional line. In FIG. 15C, a radius of the arc showing the first inner tapered part 11T is q0, and a radius of the arc showing the first outer tapered part 11U is qn. In this case, a first inner inclination angle θ1 is an angle of a tangent of a circle having the radius q0 at a starting point on the outer side of the first inner tapered part 11T with respect to a plane orthogonal to the first direction (XY plane). Similarly, a first outer inclination angle o1 is an angle of a tangent of a circle having the radius qn at a starting point on the inner side of the first outer tapered part 11U with respect to a plane orthogonal to the first direction (XY plane).

When comparing the coil component 107 according to the eighth embodiment with the coil component 106 according to the seventh embodiment, with respect to the first bottom surface 201A, in the case of the coil component 107 according to the eighth embodiment, when cut along the first cross section, in at least a part of a cross-sectional line, which shows on the first cross section a portion of the first bottom surface 201A other than the first inner tapered part 11T and other than the first outer tapered part 11U, an inclination angle with respect to the first direction (Z1-Z2 direction) may be other than 90°. When comparing the coil component 107 according to the eighth embodiment with the coil component 106 according to the seventh embodiment, with respect to the second bottom surface 202A, like the first bottom surface 201A, in the case of the coil component 107 according to the eighth embodiment, when cut along the first cross section, in at least a part of a cross-sectional line, which shows on the first cross section a portion of the second bottom surface 202A other than the second inner tapered part 21T and other than the second outer tapered part 21U, an inclination angle with respect to the first direction (Z1-Z2 direction) may be other than 90°. In a case that this inclination angle is 90°, it becomes parallel to the first main body surface 301.

Specifically, both the first bottom surface 201A and the second bottom surface 202A of the coil component 106 according to the seventh embodiment are parallel to the first main body surface 301 and the second main body surface 302. In contrast, in the coil component 107 according to the eighth embodiment, as shown in FIG. 16, the first bottom surface 201A has a tapered structure that becomes farther from the first main body surface 301 toward the inner side. The first inner tapered part 11T is provided as a region where the degree of separation from the first main body surface 301 is greater than that of the first bottom surface 201A having this tapered structure, and the first outer tapered part 11U has a tapered structure inclined in a direction opposite to the inclination of the tapered structure of the first bottom surface 201A.

The second bottom surface 202A also has, similarly to the first bottom surface 201A, a tapered structure that becomes more separated from the second main body surface 302 toward the inner side, and a second inner tapered part 21T is provided as a region where the degree of separation from the second main body surface 302 is greater than that of this tapered structure. The second outer tapered part 210 has a tapered structure that inclines in a direction opposite to the inclination of the tapered structure of the first bottom surface 201A.

In the coil component 107 according to the eighth embodiment, similarly to the coil component 106 according to the seventh embodiment, a first inner corner part 11R, a first outer corner part 11S, a second inner corner part 21R, and a second outer corner part 21S are provided.

When comparing the coil component 108 according to the ninth embodiment with the coil component 107 according to the eighth embodiment, with respect to the first bottom surface 201A, in both cases, when cut along the first cross section, in at least a part of a cross-sectional line, which shows on the first cross section a portion of the first bottom surface 201A other than the first inner tapered part 11T and other than the first outer tapered part 11U, an inclination angle with respect to the first direction (Z1-Z2 direction) may be other than 90°. While both share a tapered structure that is farther from the first main body surface 301 toward the inner side, the details of this tapered structure are different. In other words, in the coil component 108 according to the ninth embodiment, a cross-sectional line, by which the first bottom surface 201A on the Y1 side in the Y1-Y2 direction is drawn on the first cross section, as shown by a phantom line L1 in FIG. 17, has a convex shape with a central portion in the Y1-Y2 direction bulging toward the first main body surface 301. Likewise, the second bottom surface 202A of the second spiral conductor portion 21 has a convex shape with a central portion in the Y1-Y2 direction bulging toward the second main body surface 302. With the tapered structures, regions with locally increased magnetic resistance in the magnetic path between the first main body surface 301 and the first bottom surface 201A and in the magnetic path between the second main body surface 302 and the second bottom surface 202A can be minimized to the greatest extent, thereby potentially maximizing the improvement on the characteristics of the coil component 108.

When comparing the coil component 109 according to the tenth embodiment with the coil component 107 according to the eighth embodiment, with respect to the first bottom surface 201A, in both cases, when cut along the first cross section, in at least a part of a cross-sectional line, which shows on the first cross section a portion of the first bottom surface 201A other than the first inner tapered part 11T and other than the first outer tapered part 11U, an inclination angle with respect to the first direction (Z1-Z2 direction) may be other than 90°. While both share a tapered structure that is farther from the first main body surface 301 toward the inner side, the details of this tapered structure are different. In other words, in the coil component 109 according to the tenth embodiment, a cross-sectional line, by which the first bottom surface 201A is drawn on the first cross section, as shown by a phantom line L2 in FIG. 18, has a concave shape with a central portion in the Y1-Y2 direction denting away from the first main body surface 301. Likewise, the second bottom surface 202A of the second spiral conductor portion 21 has a concave shape with a central portion in the Y1-Y2 direction denting away from the second main body surface 302.

### (Other Shape Characteristics)

Hereinafter, based on the aforementioned simulation results (series A˜series C), the results of further examination of the shape characteristics of the coil component 100 according to the first embodiment are described.

The coil component 100 according to the first embodiment may preferably have a first parameter, expressed as p0×h/t with the turn thickness t, top-bottom thickness h, and inner side chamfer width p0, being 5.0 μm⁻¹ or more and 35 μm⁻¹ or less. Table 7 shows the results of examining the shape characteristics.

TABLE 7

| | | | | | | Δ |
|---|---|---|---|---|---|---|
| No. | P0 × h/t | X | Y | XY² | Z | [%] |
| A-0 | 0 | 1.000 | 0.00 | 0.000 | 0.00 | 0.00 |
| A-1 | 17.85 | 0.986 | 0.34 | 0.112 | 0.81 | −0.10 |
| A-2 | 35.7 | 0.944 | 0.68 | 0.431 | 1.55 | −0.44 |
| A-3 | 59.5 | 0.844 | 1.00 | 0.844 | 2.43 | −2.84 |
| A-4 | 83.3 | 0.775 | 1.00 | 0.775 | 2.84 | −8.26 |
| B-0 | 0 | 1.000 | 0.00 | 0.000 | 0.00 | 0.00 |
| B-1 | 12.375 | 0.986 | 0.13 | 0.018 | 0.27 | 0.53 |
| B-2 | 24.75 | 0.945 | 0.27 | 0.068 | 0.52 | 1.16 |
| B-3 | 41.25 | 0.847 | 0.45 | 0.170 | 0.83 | 0.06 |
| B-4 | 56.1 | 0.717 | 0.61 | 0.266 | 1.09 | −3.99 |
| C-0 | 0 | 1.000 | 0.00 | 0.000 | 0.00 | 0.00 |
| C-1 | 6.9 | 0.987 | 0.05 | 0.003 | 0.08 | 1.00 |
| C-2 | 13.8 | 0.946 | 0.10 | 0.010 | 0.16 | 2.03 |
| C-3 | 23 | 0.851 | 0.17 | 0.026 | 0.27 | 1.81 |
| C-4 | 25.76 | 0.813 | 0.20 | 0.031 | 0.30 | 1.64 |

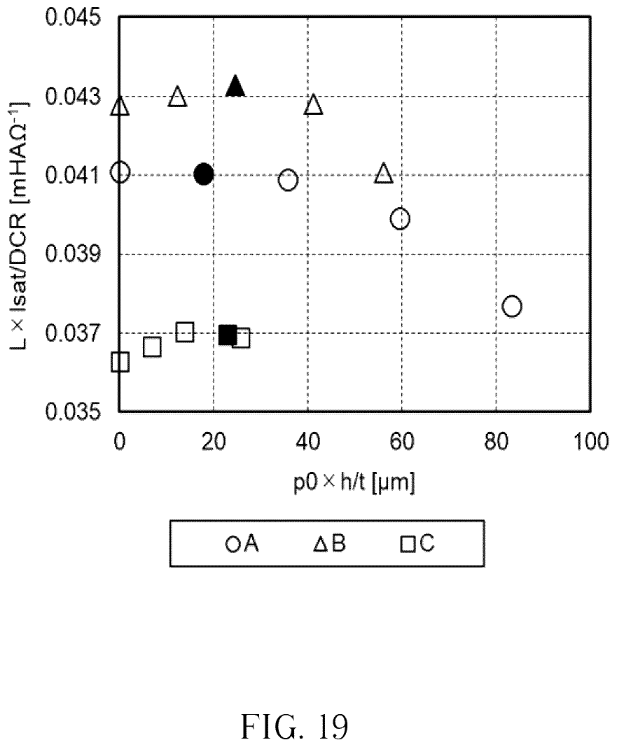

FIG. 19 is a graph showing the relationship between the first parameter (p₀×h/t) and the comprehensive characteristic L×Isat/DCR. In each of the cases having satisfactory results, at t=15 in series A (indicated by circles in FIG. 19 and filled black circles for the favorable result), t=30 in series B (indicated by triangles in FIG. 19 and filled black triangles for the favorable result), and t=30 in series C (indicated by squares in FIG. 19 and filled black squares for the favorable result), all fall within the range of 5.0 μm⁻¹ to 35 μm⁻¹. The first parameter is preferably in the range of 17.9 μm⁻¹ to 24.8 μm⁻¹.

From the perspective of extracting the shape characteristics of the coil component 100 according to the first embodiment, when the inner peripheral edge of the annular conductor portion 203 is viewed in the first direction (Z1-Z2 direction), as shown in FIG. 14, it is approximated as having the shape of elongated circle (inner elongated circle OV0) including two semicircle portions with a radius r0 (unit: μm) and a linear portion of length a0 (unit: μm) extending in the second direction (XY-plane direction, specifically the X1-X2 direction) between the two semicircle portions, which is orthogonal to the first direction (Z1-Z2 direction). Likewise, when the outer peripheral edge of the annular conductor portion 203 is viewed in the first direction (Z1-Z2 direction), it is approximated as having the shape of elongated circle (outer elongated circle OVn) including two semicircle portions with a radius rn, which share the same center as the two semicircle portions of the inner elongated circle OV0, and a linear portion of length an (unit: μm) extending in the second direction (XY-plane direction, specifically the X1-X2 direction) between the two semicircle portions. These definitions are as shown in FIG. 14.

In other words, an elongated circle defined between the inner elongated circle OV0 and the outer elongated circle OVn, whose two semicircle centers are identical to the centers of the two semicircle portions of the inner elongated circle OV0, is referred to as the intermediate elongated circle OVi (indicated by a phantom line in FIG. 14). For this intermediate elongated circle OVi, the radius of each of the two semicircle portions is denoted as ri (unit: μm), the length of the linear portion is denoted as ai (unit: μm), and the average gap distance between the annular conductor portion 203 at the position of the intermediate elongated circle OVi and the first main body surface 301 is denoted as hi (unit: μm).

In this case, the second parameter defined by 2×(π×ri+ai)×hi/r0/(π×r0+2×a0) is preferably in the range of 0.8 to 1.2. Accordingly, the first portion of the main body portion 30, which is located between the first main body surface 301 and the annular conductor portion 203, is cut along a cutting plane passing through the intermediate elongated circle OVi and extending in the first direction (Z1-Z2 direction) to obtain a first intermediate cross section with an area Ai (unit: μm²). The inner elongated circle OV0, when viewed in the first direction, has an area Ain (unit: μm²). A ratio of the area Ai to the area Ain is preferably in the range of 0.8 to 1.2. When current flows through the coil component 100, a magnetic field generated around the annular conductor portion 203 is less likely to cause a local increase in magnetic resistance.

When the elongated circle located between the inner elongated circle OV0 and the outer elongated circle OVn having respective centers of two semicircle portions thereof the same as the centers of the two semicircle portions of the inner elongated circle OV0, and closest to the outer peripheral edge of the first inner tapered part 11T, is defined as the taper-end elongated circle OV1 (see FIG. 14), a third parameter represented by X·Y² is ranged between 0.0020 and 0.20, wherein X is represented by an expression (2) and Y is represented by an expression (3):

$$X = 1 - p {0}^{2} / ( 2 \times t \times W ) \times tan θ 1 \qquad ( 2 )$$

$$Y = min [ ( min ( A 0 , A 1 ) - A 0 ini ) / ( Ain - A 0 ini ) , 1 ] . \qquad ( 3 )$$

Herein, W (unit: μm) is an average width of a turn of the annular conductor portion 203, where a tapered part (inner tapered part, outer tapered part) is present, in the spiral direction (see FIG. 5B). In the present disclosure, the “width of a turn” is defined as the distance, when viewed in the first direction, between any one point on the inner circumference of the turn and the point on the outer circumference of the turn, which is closest to that point on the outer circumference. min (α, β) is a function to return the smaller of α and β. A0 (unit: μm²) is an area of a first inner cross section obtained by cutting the first portion along a cutting plane passing through the inner elongated circle OV0 and extending in the first direction (Z1-Z2 direction). A1 (unit: μm²) is an area of a first taper-end cross section obtained by cutting the first portion along a cutting plane passing through the taper-end elongated circle OV1 and extending in the first direction. Ain (unit: μm²) is an area of the inner elongated circle OV0 as viewed in the first direction. A0ini (unit: μm²) is an area of a virtual inner cross section obtained by cutting a virtual member, in which the annular conductor portion 203 does not include the first inner tapered part 11T, along a cutting plane passing through the inner elongated circle OV0 and extending in the first direction.

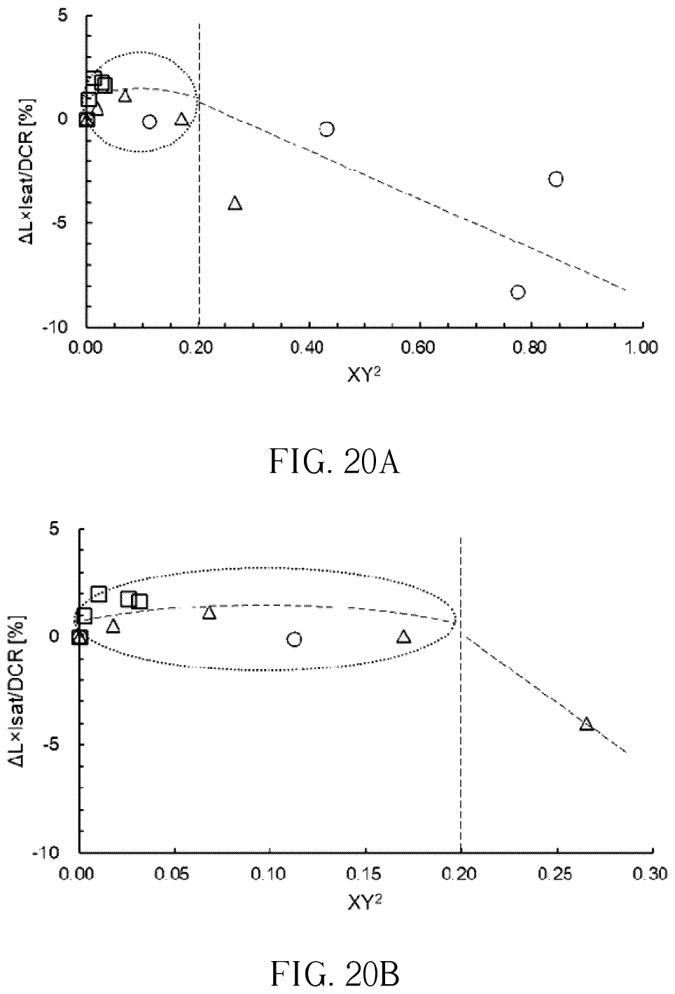

FIG. 20A is a graph illustrating the shape-related characteristics of a coil component according to an embodiment of the present invention, showing the relationship between the change rate Δ of comprehensive characteristic L×Isat/DCR and a third parameter (XY²). FIG. 20B is a graph in which the range of the horizontal axis in the graph shown in FIG. 20A is set to 0.00 to 0.30. Here, the change rate Δ of the comprehensive characteristic Lx Isat/DCR is calculated as follows: For series A, it is the change rate obtained by comparing the results from A-1 to A-4 against the result from A-0. For series B, it is the change rate obtained by comparing the results from B-1 to B-4 against the result from B-0. For series C, the results for C-1 through C-4 represent the change rate calculated based on the results for C-0. As shown in FIG. 20A and FIG. 20B, when the third parameter falls within the range between 0.0020 and 0.20, the change rate Δ in the comprehensive characteristic L×Isat/DCR tends to be higher compared to when it is beyond this range.

Furthermore, the elongated circle located between the inner elongated circle OV0 and the outer elongated circle OVn having respective centers of two semicircle portions thereof the same as the centers of the two semicircle portions of the inner elongated circle OV0, and closest to the outer peripheral edge of the first inner tapered part 11T, is defined as the taper-end elongated circle OV1, the radii of the two semicircle portions of the taper-end length elongated circle OV1 are defined as r1 (unit: μm), the length of the linear portion is defined as a1 (unit: μm), and the average gap distance between the annular conductor portion 203 at the position of the tapered end major ellipse OV1 and the first main body surface 301 is defined as h1 (unit: μm).

In this case,
a fourth parameter represented by Z with an expression (4) is 0.80 or less:

$$Z = p 0 / [ \{ r 0 \times ( π r 0 + 2 \times a 0 ) / ( 2 \times π \times h 1 ) \} - ( a 1 / π ) - r 0 ] \times [ tan θ 1 - π \times h 0 / \{ π \times ( r 0 + p 0 ) + a 0 \} ] . \qquad ( 4 )$$

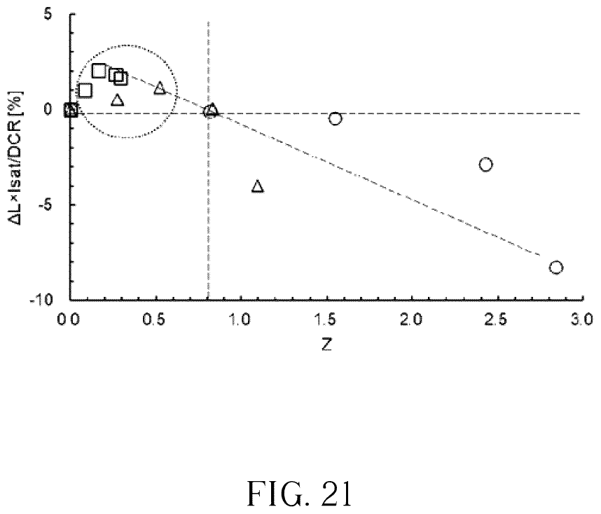

FIG. 21 is a graph illustrating the shape-related characteristics of a coil component according to an embodiment of the present invention, showing the relationship between the change rate Δ of the comprehensive characteristic L×Isat/DCR and the fourth parameter (Z). As shown in FIG. 21, when the fourth parameter is within the range of 0.80 or less, the change rate Δ in the overall characteristic L×Isat/DCR tends to be higher compared to the case beyond this range. The fourth parameter may be 0.010 or greater. From the perspective of improving L and Isat, it is preferable for the fourth parameter to be 0.10 or greater.

Furthermore, a0 may be substantially 0 μm, and the inner peripheral edge of the first annular conductor portion may have a substantially circular shape.

The average gap distance h0 (unit: μm) of the annular conductor portion 203 at the position of the inner elongated circle OV0 of the annular conductor portion 203 from the first main body surface 301, the average gap distance hn (unit: μm) of the annular conductor portion 203 at the position on the outer elongated circle OVn of the annular conductor portion 203 from the first main body surface 301 is defined. In this case, a fifth parameter represented by (sn/s0)/(rn/r0)/(hn/h0) may preferably be between 0.8 and 1.2. When the fifth parameter falls within this range, the cross-sectional area of the cross section perpendicular to the magnetic path direction in a portion of the main body portion 30, which may cause a local increase in magnetic resistance, is less likely to decrease, making it easier to improve the characteristics of the coil component 100.

Those skilled in the art will readily observe that numerous modifications and alterations of the device and method may be made while retaining the teachings of the invention. Accordingly, the above disclosure should be construed as limited only by the metes and bounds of the appended claims.

For example, as a modified example of the coil component 106 according to the seventh embodiment, the first annular conductor portion (first spiral conductor portion 11) may have a third inner corner part connecting the first bottom surface 201A and the first inner tapered part 11T with a continuous surface, and a third outer corner part connecting the first bottom surface 201A and the first outer tapered part 11U with a continuous surface. Similarly, the second annular conductor portion (second spiral conductor portion 21) may have a fourth inner corner part connecting the second bottom surface 202A and the second inner tapered part 21T with a continuous surface, and a fourth outer corner part connecting the second bottom surface 202A and the second outer tapered part 21U with a continuous surface.

What is claimed is:

1. A coil component, comprising:
a coil member comprising a coil conductor portion, wherein the coil conductor portion comprises an annular conductor portion, and the annular conductor portion comprises a pair of bottom surfaces arranged in a first direction and revolving around a first central axis along the first direction; and
a main body portion covering the pair of bottom surfaces of the annular conductor portion with a pair of intersecting surfaces arranged in the first direction, wherein the main body comprises a magnetic powder,
wherein the coil member is characterized in that:
the annular conductor portion comprises a first bottom surface facing a first main body surface, which is one of the pair of intersecting surfaces; a second bottom surface facing a second main body surface, which is the other of the pair of intersecting surfaces;
and a first inner surface and a first outer surface located between the first bottom surface and the second bottom surface;
the first bottom surface comprises a first inner tapered part configured so that the first bottom surface is farther from the first main body surface toward the first inner surface; and
a first inner inclination angle θ1 of the first inner tapered part with respect to a plane orthogonal to the first direction is 50° or less.

2. The coil component according to claim 1, wherein:
the second bottom surface comprises a second inner tapered part configured so that the second bottom surface is farther from the second main body surface toward the first inner surface, and
a second inner inclination angle θ2 of the second inner tapered part with respect to a plane orthogonal to the first direction may be 50° or less.

3. The coil component according to claim 2, wherein:
the annular conductor portion includes a first annular conductor portion and a second annular conductor portion, which are symmetrical with respect to a plane orthogonal to a first direction,
a first inner tapered part is provided in the first annular conductor portion, and
a second inner tapered part is provided in the second annular conductor portion, and
in a case where:
an average length of the first annular conductor portion in the first direction is defined as t (μm),
an average gap distance in the first direction between an end part of the first bottom surface of the first annular conductor portion and the first main body surface is defined as h (μm), and
an average gap distance in the first direction between an outer peripheral edge and an inner peripheral edge of the first inner tapered part is defined as p1 (μm),
an expression (1) is satisfied:
$$t / h \times 25 μ m - 4.85 μ m \leq p 0 \leq t / h \times 25 μ m + 5.15 μ m . \qquad ( 1 )$$

4. The coil component according to claim 3, wherein t/h is defined as a first ratio:
p₀ is 10 μm or more and 20 μm or less when the first ratio is less than 1.0,
p₀ is 25 μm or more and 35 μm or less when the first ratio is 1.0 or more and less than 1.5, and
p₀ is 45 μm or more and 55 μm or less when the first ratio is 1.5 or more.

5. The coil component according to claim 1, wherein the annular conductor portion comprises a first inner corner part, which connects the first inner surface and the first inner tapered part with a continuous surface.

6. The coil component according to claim 5, wherein:
when the coil component is cut along the first direction through the first inner surface to obtain a first cross section, which has a minimal cross-sectional area of the first annular conductor portion,
the cross-sectional line, by which a first inner corner part is drawn on the first cross section, has a shape approximated by an arc of a circle having a radius s0 (μm).

7. The coil component according to claim 2, wherein:
the annular conductor portion comprises:
a first spiral conductor portion having a pair of bottom surfaces arranged in the first direction and having a plurality of turns that revolve around the first central axis;
a second spiral conductor portion having a pair of bottom surfaces arranged in the first direction, having a plurality of turns that revolve around the first central axis from an inner side to an outer side, and arranged in the first direction with the first spiral conductor portion; and
a via member in contact with one end of the inner side of the first spiral conductor portion and one end of the inner side of the second spiral conductor portion to electrically connect the first spiral conductor portion and the second spiral conductor portion,
the first inner tapered part is provided on the side where the first spiral conductor portion is located in the first direction, and
the second inner tapered portion is provided on the side where the second spiral conductor portion is located in the first direction.

8. The coil component according to claim 1, wherein:
the first bottom surface comprises a first outer tapered part configured so that the first bottom surface is farther from the first main body surface toward the first outer surface; and
a first outer inclination angle o1 of the first outer tapered part with respect to a plane orthogonal to the first direction is 50° or less.

9. The coil component according to claim 1, wherein:
the second bottom surface comprises a second outer tapered part configured so that the second bottom surface is farther from the second main body surface toward the first outer surface; and
a second outer inclination angle φ2 of the second outer tapered part with respect to a plane orthogonal to the first direction is 50° or less.

10. The coil component according to claim 8, wherein the annular conductor portion comprises:
a first inner corner part connecting the first inner surface and the first inner tapered part with a continuous surface; and
a first outer corner part connecting the first outer surface and the first outer tapered part with a continuous surface.

11. The coil component according to claim 10, wherein:
when the annular conductor portion is cut at a first cross section orthogonal to a current path of the annular conductor portion and along the first direction,
a cross-sectional line, by which the first inner corner part is drawn on the first cross section, has a shape approximated by an arc of a circle having a radius s0 (unit: μm), and
a cross-sectional line, by which the first outer corner part is drawn on the first cross section, has a shape approximated by an arc of a circle having a radius sn (unit: μm),
wherein sn/s0 is 0.8 or more and 1.2 or less.

12. The coil component according to claim 8, wherein:
when the annular conductor portion is cut at a first cross section orthogonal to a current path of the annular conductor portion and along the first direction,
in at least a part of a cross-sectional line, by which a portion of the first bottom surface other than the first inner tapered part and other than the first outer tapered part is drawn on the first cross section, an inclination angle with respect to the first direction is other than 90°.

13. The coil component according to claim 1, wherein:
in a case where:
an average length of the first annular conductor portion in the first direction is set to be a turn width t (μm),
an average gap distance in the first direction between a portion of the first bottom surface, where the first inner tapered part is not provided, and the first main body surface is set to be a top-bottom thickness h (μm), and
an average gap distance viewed in the first direction between an outer peripheral edge and an inner peripheral edge of the first inner tapered part is set to be an inner chamfer width p₀ (μm), a first parameter defined as p₀×h/t is 5.0 μm⁻¹ or more and 35 μm⁻¹ or less.

14. The coil component according to claim 1, wherein:
an inner peripheral edge of the annular conductor portion, when viewed in the first direction, has a shape approximated by an inner elongated circle, which is an elongated circle including two semicircle portions, each having a radius r0 (μm), and a linear portion extending in a second direction orthogonal to the first direction between the two semicircle portions and having a length a0 (μm),
an outer peripheral edge of the annular conductor portion, when viewed in the first direction, has a shape approximated by an outer elongated circle, which is an elongated circle including two semicircle portions, having same centers as those of the two semicircle portions of the inner elongated circle and each having a radius rn (μm), and a linear portion extending in the second direction between the two semicircle portions and having a length an (μm),
an intermediate elongated circle is defined as an elongated circle between the inner elongated circle and the outer elongated circle, including two semicircle portions having same centers as those of the two semicircle portions of the inner elongated circle, the intermediate elongated circle includes the two semicircle portions having a radius ri (μm), respectively, and a linear portion having a length ai (μm), and
when an average gap distance between the annular conductor portion at a position of the intermediate elongated circle and the first main body surface is defined as hi (μm), a second parameter defined by 2×(π×ri+ai)×hi/r0/(π×r0+2×a0) is 0.8 or more and 1.2 or less.

15. The coil component according to claim 1, wherein:
an inner peripheral edge of the annular conductor portion, when viewed in the first direction, has a shape approximated by an inner elongated circle, which is an elongated circle including two semicircle portions, each having a radius r0 (μm), and a linear portion extending in a second direction orthogonal to the first direction between the two semicircle portions and having a length a0 (μm),
an outer peripheral edge of the annular conductor portion, when viewed in the first direction, has a shape approximated by an outer elongated circle, which is an elongated circle including two semicircle portions, having same centers as those of the two semicircle portions of the inner elongated circle and each having a radius rn (μm), and a linear portion extending in the second direction between the two semicircle portions and having a length an (μm),
in a case where a taper-end elongated circle is defined as an elongated circle between the inner elongated circle and the outer elongated circle, which includes two semicircle portions having same centers as those of the two semicircle portions of the inner elongated circle, and is an elongated circle closest to an outer peripheral edge of the first inner tapered part,
a third parameter represented by X·Y² is 0.0020 or more and 0.20 or less, wherein X is represented by an expression (2) and Y is represented by an expression (3):
$$X = 1 - p {0}^{2} / ( 2 \times t \times W ) \times tan θ 1 \qquad ( 2 )$$
$$Y = min [ ( min ( A 0 , A 1 ) - A 0 ini ) / ( Ain - A 0 ini ) , 1 ] \qquad ( 3 )$$
where:
p₀ (μm) is an average gap distance in the first direction between an outer peripheral edge and an inner peripheral edge of the first inner tapered part,
W (μm) is a width of a turn forming the annular conductor portion in a direction orthogonal to the first direction,
min (α, β) is a function to return the smaller of α and β;
A0 (μm²) is an area of a first inner cross section obtained by cutting a first portion, which is located between the first main body surface and the annular conductor portion in the main body portion, along a cutting plane passing through the inner elongated circle and extending in the first direction,
A1 (μm²) is an area of a first taper-end cross section obtained by cutting the first portion along a cutting plane passing through the taper-end elongated circle and extending in the first direction,
Ain (μm₂) is an area of the inner elongated circle as viewed in the first direction, and
A0ini (μm²) is an area of a virtual inner cross section obtained by cutting a virtual member, in which the annular conductor portion 203 does not include the first inner tapered part 11T, along a cutting plane passing through the inner elongated circle OV0 and extending in the first direction.

16. The coil component according to claim 1, wherein:
an inner peripheral edge of the annular conductor portion, when viewed in the first direction, has a shape approximated by an inner elongated circle, which is an elongated circle including two semicircle portions, each having a radius r0 (μm), and a linear portion extending in a second direction orthogonal to the first direction between the two semicircle portions and having a length a0 (μm),
an outer peripheral edge of the annular conductor portion, when viewed in the first direction, has a shape approximated by an outer elongated circle, which is an elongated circle including two semicircle portions, having same centers as those of the two semicircle portions of the inner elongated circle and each having a radius rn (μm), and a linear portion extending in the second direction between the two semicircle portions and having a length an (μm),
in a case where a taper-end elongated circle is defined as an elongated circle between the inner elongated circle and the outer elongated circle, which includes two semicircle portions having same centers as those of the two semicircle portions of the inner elongated circle, and is an elongated circle closest to an outer peripheral edge of the first inner tapered part,
a fourth parameter represented by Z with an expression (4) is 0.80 or less:
$$Z = p 0 / [ \{ r 0 \times ( π r 0 + 2 \times a 0 ) / ( 2 \times π \times h 1 ) \} - ( a 1 / π ) - r 0 ] \times [ tan θ 1 - π \times h 0 / \{ π \times ( r 0 + p 0 ) + a 0 \} ] \qquad ( 4 )$$
where:
p₀ (μm) is an average gap distance in the first direction between an outer peripheral edge and an inner peripheral edge of the first inner tapered part,
r1 (μm) is a radius of each of two semicircle portions of the taper-end elongated circle,
a1 (μm) is a length of a linear portion of the taper-end elongated circle, and
h1 (μm) is an average gap distance between the annular conductor portion at a position of the taper-end elongated circle and the first main body surface.

17. The coil component according to claim 16, wherein the inner peripheral edge of the annular conductor portion has a substantially circular shape.

18. An electronic/electric device, installed therein the coil component according to claim 1, wherein the coil component includes a pair of external electrodes connected to a pair of end parts of the coil member, and is connected to a substrate via the pair of external electrodes.
